(19) United States
(12) Patent Application Publication
(10) Pub. No.: US 2026/0320926 A1
(43) Pub. Date: Oct. 15, 2026

(54) Spatial Computing Toolkit for Supporting Interactive Data Narratives

(71) Applicant: Salesforce, Inc., San Francisco, CA (US)

(72) Inventors: Samuel Jean Claude RIDET, San Francisco, CA (US); Vidya Raghavan SETLUR, Portola Valley, CA (US)

(21) Appl. No.: 19/646,491

(22) Filed: Apr. 13, 2026

Related U.S. Application Data
(60) Provisional application No. 63/788,716, filed on Apr. 14, 2025.
(60) Provisional application No. 63/824,804, filed on Jun. 16, 2025.

(51) Int. Cl. G06T 19/00; G06T 17/05; G06V 20/70

(52) U.S. Cl. CPC G06T 19/003; G06T 17/05; G06V 20/70

(57) ABSTRACT

A computer system obtains structured event data and spatial visual assets corresponding to a data narrative. The computer system binds portions of the structured event data to respective scene objects associated with the spatial visual assets, including associating the respective scene objects with spatial metadata and temporal metadata. The system generates, based on the binding, narrative transition logic and one or more contextual narrative assets for the data narrative. The computer system constructs, based on the narrative transition logic, presentation data for the data narrative. The computer system generates interaction-linked presentation data that associates a respective scene object of the respective scene objects with context-specific narrative content and a corresponding localized immersive presentation. The computer system transmits the presentation data and the interaction-linked presentation data to a spatial computing device that is configured to perform playback of the data narrative in a spatial computing environment.

### RELATED APPLICATIONS

This application claims priority to (i) U.S. Provisional Application No. 63/788,716, filed Apr. 14, 2025; and (ii) U.S. Provisional Application No. 63/824,804, filed Jun. 16, 2025, each of which is incorporated by reference herein in its entirety.

### TECHNICAL FIELD

The disclosed embodiments relate generally to data analysis, and more specifically, to systems, methods, and user interfaces for generating immersive data stories and immersive data narratives in a spatial computing environment.

### BACKGROUND

The goal of data analysis and data storytelling extends beyond merely generating statistical output, charts, dashboards, or maps; these activities relate to extracting and communicating insights from data that may have spatial, temporal, and contextual dimensions.

### SUMMARY

Data storytelling is a data-driven process where stories are crafted around data and communicated to audiences to enable them to understand the significance of the data in a relatable and engaging way.

Many existing computing environments for data analysis remain constrained in how such information is presented and explored. For example, traditional data storytelling and visual analytics tools rely primarily on two-dimensional (2D) charts, dashboards, and static maps, which can be limiting for exploring complex, multidimensional datasets. As datasets become richer and more multidimensional, these presentation approaches can increase cognitive burden, interrupt analytical flow, and limit a user's ability to remain oriented while exploring a developing narrative. Additionally, existing business intelligence (BI) and historical visualization tools are typically confined to desktop interfaces, lacking immersive and interactive capabilities that can enhance data comprehension.

Accordingly, there is a need for improved systems, methods, and user interfaces for presenting and exploring data narratives in computing environments, particularly in applications involving multidimensional information, evolving events, and context-dependent interpretation.

The evolution of spatial computing and head-mounted displays (HMDs) has opened new paradigms in digital storytelling, enabling data narratives to move beyond static visualizations into fully interactive, immersive experiences. Unlike traditional data storytelling, immersive data storytelling can integrate principles from narrative visualization, virtual reality (VR), and augmented reality (AR) to create interactive experiences that blend exploration, interactivity, and structured storytelling. However, designing effective immersive storytelling experiences requires new methodologies that incorporate principles from both traditional visual analytics and emerging immersive technologies. Presently, there is limited guidance on how to build such experiences or adapt traditional narrative visualizations to this medium.

To address these issues, the present disclosure provides a spatial computing toolkit and framework for generating immersive data narratives in a computer-generated reality environment. In some embodiments, structured event data and one or more spatial visual assets are bound to scene objects having associated spatial metadata and temporal metadata, thereby enabling construction of a semantically meaningful scene graph and corresponding narrative transition logic for the data narrative. Based on these bindings, the toolkit can generate contextual narrative assets such as data cards, spatial markers, and audio narratives, and can render a synchronized overview presentation together with one or more localized immersive presentations that can be selectively accessed through gaze inputs, gesture inputs, voice commands, or other user interactions. By coordinating scene construction, narrative sequencing, contextual asset generation, and interactive transitions within a shared spatial environment, the disclosed techniques support guided walkthroughs and open exploration of complex data stories in a manner that can improve comprehension, preserve user orientation, and align narrative content with underlying spatial and temporal data.

The systems, methods, and user interfaces of this disclosure each have several innovative aspects, no single one of which is solely responsible for the desirable attributes disclosed herein.

In accordance with some embodiments, a method for generating immersive data narratives is performed at a computer system that includes one or more processors and memory. The method comprises obtaining structured event data and one or more spatial visual assets corresponding to a data narrative. The method comprises binding portions of the structured event data to respective scene objects associated with the one or more spatial visual assets, including associating the respective scene objects with spatial metadata and temporal metadata. The method comprises generating, based on the binding, narrative transition logic and one or more contextual narrative assets for the data narrative. The method comprises constructing, based on the narrative transition logic, presentation data for the data narrative, the presentation data including data for an overview presentation of the data narrative. The method comprises generating interaction-linked presentation data that associates a respective scene object of the respective scene objects with context-specific narrative content and a corresponding localized immersive presentation. The method also comprises transmitting the presentation data and the interaction-linked presentation data to a spatial computing device that is separate from the computer system, the spatial computing device configured to perform playback of the data narrative in a spatial computing environment.

In accordance with some embodiments, a spatial computing framework for generating immersive data stories includes a data processing module configured to provide structured storytelling data and one or more three-dimensional models corresponding to an immersive data story configured for playback on a spatial computing device. The spatial computing framework includes a storytelling engine configured to process the structured storytelling data to generate scene sequencing, narration, and branching logic for the immersive data story, wherein the storytelling engine is further configured to adapt the scene sequencing, the narration, or the branching logic based on user interaction. The spatial computing framework includes a rendering engine configured to render, based on the structured storytelling data and the one or more three-dimensional models, a macro-level overview comprising a data dashboard and a location-specific immersive scene corresponding to a spatial location represented in the immersive data story. The spatial computing framework includes a user interactivity controls module configured to receive gesture inputs, gaze inputs, and voice commands from a user, wherein the user interactivity controls module is configured to cause, based on the gesture inputs, the gaze inputs, or the voice commands, a transition between the macro-level overview and the location-specific immersive scene and to provide the user interaction to the storytelling engine to adapt the immersive data story.

In accordance with some embodiments, a method for generating immersive data stories in a spatial computing environment is performed at a computer system that includes one or more processors and memory. The method includes providing, by a data processing module, structured storytelling data and one or more three-dimensional models corresponding to the immersive data story. The method includes processing, by a storytelling engine, the structured storytelling data to generate scene sequencing, narration, and branching logic for the immersive data story. The method includes rendering, by a rendering engine and based on the structured storytelling data and the one or more three-dimensional models, a macro-level overview comprising a data dashboard and a location-specific immersive scene corresponding to a spatial location represented in the immersive data story. The method includes receiving, by a user interactivity controls module, gesture inputs, gaze inputs, and voice commands from a user. The method includes causing, by the user interactivity controls module and based on the gesture inputs, the gaze inputs, or the voice commands, a transition between the macro-level overview and the location-specific immersive scene. The method includes adapting, by the storytelling engine, the scene sequencing, the narration, or the branching logic based on the gesture inputs, the gaze inputs, or the voice commands received from the user.

In accordance with some embodiments, a toolkit for generating an immersive data story for presentation on a spatial computing device includes a data asset management module configured to receive structured data, storytelling assets, and one or more three-dimensional models and to bind the structured data to visual assets associated with the immersive data story. The toolkit includes a spatial scene construction module configured to generate scene objects, spatial metadata, temporal sequencing, and interaction handlers defining a scene graph for the immersive data story. The toolkit includes a storytelling asset generation module configured to generate, based on the structured data and the scene graph, one or more data cards, spatial markers, and audio narratives associated with locations represented in the immersive data story. The toolkit also includes a rendering engine configured to render, based on the scene graph, a macro-level overview and one or more location-specific immersive scenes for interactive presentation on the spatial computing device.

In accordance with some embodiments, a computer system includes one or more processors, and memory coupled to the one or more processors. The memory stores one or more programs configured for execution by the one or more processors. The one or more programs include instructions for performing any of the methods disclosed herein.

In accordance with some embodiments, a non-transitory computer readable storage medium stores one or more programs configured for execution by a computer system having one or more processors, and memory. The one or more programs include instructions for performing any of the methods disclosed herein.

Thus methods, systems, and graphical user interfaces are disclosed that generate and present immersive data stories.

Note that the various embodiments described above can be combined with any other embodiments described herein. The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes and may not have been selected to delineate or circumscribe the inventive subject matter.

### BRIEF DESCRIPTION OF THE DRAWINGS

For a better understanding of the aforementioned systems, methods, and graphical user interfaces, as well as additional systems, methods, and graphical user interfaces that provide data visualization analytics, reference should be made to the Detailed Description of Embodiments below, in conjunction with the following drawings in which like reference numerals refer to corresponding parts throughout the figures.

FIG. 1 illustrates a spatial computing framework in accordance with some embodiments.

FIG. 2 illustrates a toolkit for generating immersive data stories for presentation on a spatial computing device, in accordance with some embodiments.

FIG. 3 illustrates a format of the spatial scene construction graph generated by the toolkit, in accordance with some embodiments.

FIGS. 4A to 4X are screenshots illustrating a spatial computing environment, in accordance with some embodiments.

FIG. 5 provides a block diagram of a spatial computing device, in accordance with some embodiments.

FIG. 6 provides a block diagram of a computer system, in accordance with some embodiments.

FIG. 7 provides a flowchart of an example process for generating immersive data narratives, in accordance with some embodiments.

FIG. 8 provides a flowchart of an example process for generating immersive data narratives in a spatial computing environment, in accordance with some embodiments.

Reference will now be made to embodiments, examples of which are illustrated in the accompanying drawings. In the following description, numerous specific details are set forth in order to provide a thorough understanding of the present invention. However, it will be apparent to one of ordinary skill in the art that the present invention may be practiced without requiring these specific details.

### DETAILED DESCRIPTION OF EMBODIMENTS

The present disclosure provides a spatial computing toolkit and framework for generating immersive data narratives in a computer-generated reality environment. The spatial computing framework facilitates immersive data storytelling by supporting interaction with high-fidelity 3D models that provide geographic and spatial context for data narratives. The framework is intended to improve comprehension of complex spatial-temporal data, reduce user overwhelm through guided onboarding, and support richer engagement than conventional 2D tools. In some embodiments, the framework combines a structured guided mode with a user-driven exploration mode. Users can interact with the 3D environment through gesture-based interactions, allowing them to rotate, scale, and navigate through data-driven narratives. Additionally, a dynamic storytelling mechanism enables real-time adaptation of narratives through interactive playback controls, allowing users to explore data at their own pace. To demonstrate the utility of the toolkit, the inventors developed Charles Minard's historical flow map of Napoleon's 1812 campaign in Russia as an immersive experience on the Apple Vision Pro® platform, a canonical example of historical data storytelling. By leveraging head-mounted displays (HMDs) and spatial computing platforms such as Apple Vision Pro®, Microsoft HoloLens®, Meta Quest®, or other augmented reality (AR), virtual reality (VR), and/or mixed reality (MR) technologies, the disclosed overcomes the limitations of traditional 2D dashboards by offering an intuitive, embodied data exploration experience.

In some embodiments, the disclosed system addresses a technical problem arising in spatial computing environments in which structured event data, three-dimensional scene content, and user interaction signals are processed for real-time immersive presentation. Conventional systems that separately manage charts, maps, scene assets, and interaction events can suffer from inconsistent synchronization between overview content and localized scene content, excessive rendering overhead when transitioning into immersive presentations, and increased latency when retrieving context-specific narrative assets for selected scene objects. In some embodiments, the disclosed computer system addresses these technical issues by generating structured bindings between storytelling data and scene objects, constructing interaction-linked presentation data that associates scene objects with corresponding contextual content and localized immersive presentations, and using narrative transition logic to control scene-state changes in response to user interaction

In some embodiments, the disclosed system improves operation of a spatial computing device by preparing data structures that permit low-latency retrieval of scene-specific content during playback. For example, a computer system can generate and store interaction-linked presentation data that maps a selected scene object to corresponding contextual narrative assets, transition conditions, and a localized immersive presentation before user selection occurs. As a result, when the spatial computing device detects a gaze input, gesture input, or voice command directed to the scene object, the device can invoke the corresponding transition and present the associated content without performing repeated reconstruction of scene relationships at runtime. In some embodiments, this arrangement reduces runtime processing overhead, reduces scene-transition delay, and improves responsiveness of immersive playback on the spatial computing device.

In some embodiments, the disclosed system further improves rendering performance in a spatial computing environment by generating optimized visual assets for immersive playback. For example, the rendering engine can apply decimation, texture baking, or both to one or more three-dimensional models before or during generation of rendered assets for the immersive data story. In some embodiments, optimization of the one or more three-dimensional models reduces polygon-processing burden, reduces memory bandwidth consumption, and permits real-time presentation of synchronized dashboard content and immersive scene content on a head-mounted display device. In some embodiments, the rendering engine selectively uses optimized model data for overview rendering and localized immersive presentations while preserving scene-object identifiers and associated data bindings used by the storytelling engine and the user interactivity controls module.

In some embodiments, the disclosed system uses a scene graph and state-machine-based transition framework to improve computer control of immersive narrative progression. The scene graph can encode scene objects, identifiers, spatial metadata, temporal metadata, and interaction handlers, and the state machine can encode scene states, transition conditions, and animation sequences associated with the scene graph. By using the scene graph and the state machine together, the computer system can validate scene transitions, preserve correspondence between selected scene objects and resulting immersive presentations, and reduce errors that might otherwise arise when user interactions dynamically alter the path of exploration. In some embodiments, the state machine constrains scene transitions to permitted state changes while still allowing user-directed branching, thereby improving consistency and predictability of immersive playback.

In some embodiments, the disclosed system improves multimodal interaction processing in a spatial computing environment by integrating gesture-derived commands, gaze-derived selections, and voice-derived navigation inputs into a common interaction control path. Rather than requiring independent handling logic for separate modalities, the user interactivity controls module can normalize detected user inputs into scene-object selections, navigation requests, or transition requests that are processed according to the narrative transition logic and the interaction-linked presentation data. In some embodiments, this integrated processing reduces duplicate event handling, improves consistency of transitions across different input modalities, and enables a selected spatial marker, named location, or other scene object to invoke a corresponding localized immersive presentation through a common machine-controlled mechanism.

In some embodiments, the disclosed system is implemented as a distributed technical architecture in which authoring, data preparation, binding generation, and at least a portion of rendering preparation are performed at a computer system, while immersive playback, input sensing, and at least a portion of scene rendering are performed at a spatial computing device. The computer system can transmit presentation data and interaction-linked presentation data to the spatial computing device such that the spatial computing device performs playback using pre-associated scene relationships, contextual narrative assets, and transition definitions. In some embodiments, distributing functionality in this manner reduces computational burden at the spatial computing device, reduces repeated remote requests during immersive playback, and improves continuity of interaction within the spatial computing environment.

In some embodiments, the disclosed system does not merely present information for human review, but instead configures operation of a spatial computing device through machine-generated bindings, scene graph data, transition logic, optimized model data, and interaction-linked presentation data that collectively control rendering, scene transitions, asset retrieval, and multimodal interaction handling. The resulting immersive playback is therefore produced through a concrete technical arrangement of data structures, processing modules, and rendering operations that improve real-time spatial presentation of structured event data in a computer-generated reality environment.

In accordance with some embodiments, a computer system for generating immersive data narratives includes one or more processors and memory. The computer system obtains structured event data and one or more spatial visual assets corresponding to a data narrative. The computer system binds portions of the structured event data to respective scene objects associated with the one or more spatial visual assets, including associating the respective scene objects with spatial metadata and temporal metadata. The computer system generates, based on the binding, narrative transition logic and one or more contextual narrative assets for the data narrative. The computer system constructs, based on the narrative transition logic, presentation data for the data narrative. The presentation data includes data for an overview presentation of the data narrative. The computer system generates interaction-linked presentation data that associates a respective scene object of the respective scene objects with context-specific narrative content and a corresponding localized immersive presentation. The computer system transmits the presentation data and the interaction-linked presentation data to a spatial computing device that is distinct from the computer system, the spatial computing device configured to perform playback of the data narrative in a spatial computing environment

In some embodiments, the structured event data comprises time-series data including location data, time data, and event metadata for events of the data narrative. In some embodiments, the one or more spatial visual assets comprise a three-dimensional terrain model, one or more building models, or one or more historical reconstruction models. In some embodiments, binding portions of the structured event data to the respective scene objects includes establishing persistent linkages between data fields of the structured event data and the respective scene objects. In some embodiments, binding portions of the structured event data to the respective scene objects further includes augmenting the respective scene objects with distinct identifiers, position metadata, orientation metadata, and interaction affordances.

In some embodiments, generating the one or more contextual narrative assets includes generating one or more data cards, one or more audio narratives, and one or more spatial markers for the data narrative. In some embodiments, generating the one or more audio narratives includes converting textual narratives corresponding to the structured event data into audio narratives using a text-to-speech model. In some embodiments, generating the narrative transition logic includes defining a state machine that encodes scene states, transition conditions, and animation sequences for the data narrative.

In some embodiments, the overview presentation comprises one or more data charts or dashboards synchronized with a three-dimensional representation of the data narrative. In some embodiments, the interaction-linked presentation data is configured such that a gaze input, a gesture input, or a voice command directed to a respective scene object causes presentation of the context-specific narrative content associated with the respective scene object. In some embodiments, the corresponding localized immersive presentation includes synchronized sound effects and one or more environmental effects corresponding to an event represented by the respective scene object. In some embodiments, the narrative transition logic is configured to support a guided walkthrough mode and an exploration mode for the data narrative. In some embodiments, constructing the presentation data includes generating the overview presentation to update in real time in response to user interaction with a three-dimensional representation of the data narrative.

In accordance with some embodiments, a spatial computing framework for generating immersive data stories includes a data processing module configured to provide structured storytelling data and one or more three-dimensional models corresponding to an immersive data story configured for playback on a spatial computing device. The spatial computing framework includes a storytelling engine configured to process the structured storytelling data to generate scene sequencing, narration, and branching logic for the immersive data story. The storytelling engine is further configured to adapt the scene sequencing, the narration, or the branching logic based on user interaction. The spatial computing framework includes a rendering engine configured to render, based on the structured storytelling data and the one or more three-dimensional models, a macro-level overview comprising a data dashboard and a location-specific immersive scene corresponding to a spatial location represented in the immersive data story. The spatial computing framework includes a user interactivity controls module configured to receive gesture inputs, gaze inputs, and voice commands from a user, wherein the user interactivity controls module is configured to cause, based on the gesture inputs, the gaze inputs, or the voice commands, a transition between the macro-level overview and the location-specific immersive scene and to provide the user interaction to the storytelling engine to adapt the immersive data story.

In some embodiments, the storytelling engine is configured to provide a guided mode in which the scene sequencing and the narration are presented according to a predefined narrative progression. In some embodiments, the storytelling engine is configured to provide a free exploration mode in which a user selectively navigates among spatial locations represented in the immersive data story.

In some embodiments, the rendering engine is configured to render one or more spatial markers anchored to corresponding spatial locations in the location-specific immersive scene. In some embodiments, the user interactivity controls module is configured to detect a gaze directed to a selected one of the one or more spatial markers and, responsive to selection of the selected one of the one or more spatial markers, to cause the transition between the macro-level overview and the location-specific immersive scene corresponding to the selected one of the one or more spatial markers. In some embodiments, the rendering engine is configured to render one or more data cards comprising contextual data associated with a selected spatial location.

In some embodiments, the storytelling engine is configured to output audio narration corresponding to at least one scene of the immersive data story. In some embodiments, the storytelling engine is configured to synchronize environmental audio with the audio narration based on a scene of the immersive data story.

In some embodiments, the rendering engine is configured to optimize rendering of the one or more three-dimensional models using decimation or texture baking. In some embodiments, the user interactivity controls module is configured to receive a voice command specifying a named location represented in the immersive data story and to cause navigation to the location-specific immersive scene corresponding to the named location.

In some embodiments, a computer system (e.g., a spatial computing device) for generating immersive data stories in a spatial computing environment includes one or more processors and memory. The computer system provides structured storytelling data and one or more three-dimensional models corresponding to the immersive data story. The computer system processes the structured storytelling data to generate scene sequencing, narration, and branching logic for the immersive data story. The computer system renders, based on the structured storytelling data and the one or more three-dimensional models, a macro-level overview comprising a data dashboard and a location-specific immersive scene corresponding to a spatial location represented in the immersive data story. The computer system receives one or more gesture inputs, gaze inputs, and voice commands from a user. The computer system causes, based on the gesture inputs, the gaze inputs, or the voice commands, a transition between the macro-level overview and the location-specific immersive scene. The computer system adapts the scene sequencing, the narration, or the branching logic based on the gesture inputs, the gaze inputs, or the voice commands received from the user.

In some embodiments, the computer system presents a guided mode in which the scene sequencing and the narration are presented according to a predefined narrative progression. In some embodiments, the computer system enables a free exploration mode in which a user selectively navigates among spatial locations represented in the immersive data story.

In some embodiments, the computer system renders one or more spatial markers anchored to corresponding spatial locations in the location-specific immersive scene. In some embodiments, the computer system receiving the gaze inputs comprises detecting a gaze directed to a selected one of the one or more spatial markers. The computer system causes, responsive to selection of the selected one of the one or more spatial markers, the transition between the macro-level overview and the location-specific immersive scene corresponding to the selected one of the one or more spatial markers. In some embodiments, the computer system renders one or more data cards comprising contextual data associated with a selected spatial location.

In some embodiments, the computer system outputs audio narration corresponding to at least one scene of the immersive data story. In some embodiments, the computer system synchronizes environmental audio with the audio narration based on a scene of the immersive data story. In some embodiments, the computer system optimizes rendering of the one or more three-dimensional models using decimation or texture baking. In some embodiments, the computer system receives a voice command specifying a named location represented in the immersive data story and causes navigation to the location-specific immersive scene corresponding to the named location.

In accordance with some embodiments, a toolkit for generating an immersive data story for presentation on a spatial computing device includes a data asset management module configured to receive structured data, storytelling assets, and one or more three-dimensional models and to bind the structured data to visual assets associated with the immersive data story. The toolkit includes a spatial scene construction module configured to generate scene objects, spatial metadata, temporal sequencing, and interaction handlers defining a scene graph for the immersive data story. The toolkit includes a storytelling asset generation module configured to generate, based on the structured data and the scene graph, one or more data cards, spatial markers, and audio narratives associated with locations represented in the immersive data story. The toolkit includes a rendering engine configured to render, based on the scene graph, a macro-level overview and one or more location-specific immersive scenes for interactive presentation on the spatial computing device.

In some embodiments, the spatial scene construction module is configured to generate the scene graph to include the scene objects, the spatial metadata, and the interaction handlers associated with the immersive data story. In some embodiments, the storytelling asset generation module is configured to generate one or more spatial markers anchored to corresponding spatial locations represented in the immersive data story. In some embodiments, the spatial scene construction module is configured to generate the scene graph such that gaze-based selection of a selected one of the one or more spatial markers triggers a transition between the macro-level overview and a corresponding one of the one or more location-specific immersive scenes.

In some embodiments, the storytelling asset generation module is configured to generate one or more data cards comprising contextual data associated with respective spatial locations represented in the immersive data story. In some embodiments, the storytelling asset generation module is configured to generate audio narration corresponding to one or more scenes of the immersive data story. In some embodiments, the storytelling asset generation module is configured to generate environmental audio synchronized with the audio narration for at least one of the one or more scenes of the immersive data story.

In some embodiments, the spatial scene construction module is configured to generate the scene graph to support a guided mode having a predefined narrative progression and a free exploration mode permitting selective user navigation among spatial locations represented in the immersive data story. In some embodiments, the rendering engine is configured to optimize rendering of the one or more three-dimensional models using decimation or texture baking. In some embodiments, the spatial scene construction module is configured to generate the scene graph to associate respective named locations with corresponding location-specific immersive scenes such that a voice command specifying one of the respective named locations causes navigation to the corresponding location-specific immersive scenes

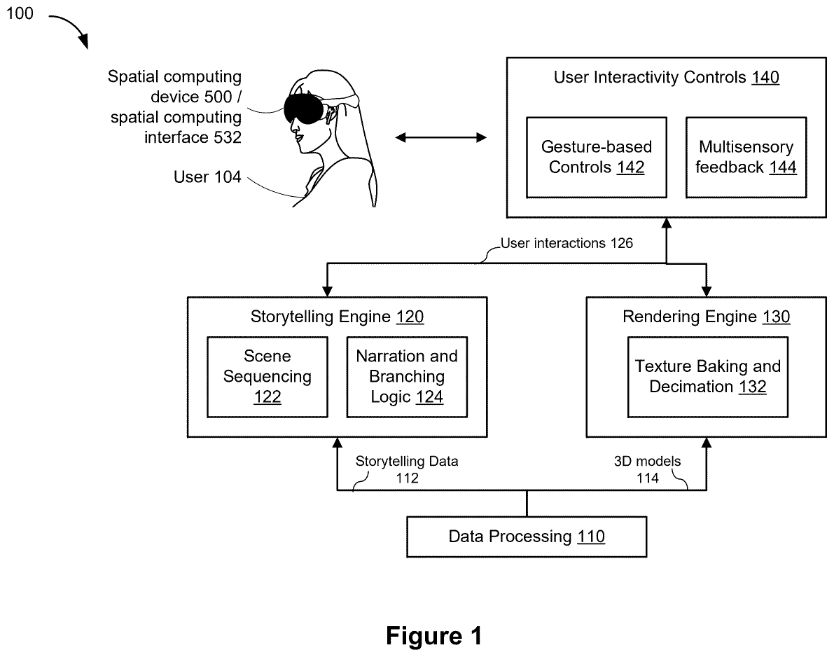

FIG. 1 illustrates a spatial computing framework 100 in accordance with some embodiments. As illustrated, the spatial computing framework 100 includes a data processing module 110, a storytelling engine 120, a rendering engine 130, a user interactivity controls module 140, and a spatial computing device 500 that includes a spatial computing interface 530.

In some embodiments, the data processing module 110 is configured to provide structured storytelling data 112 and one or more three-dimensional models 114 corresponding to an immersive data story.

The storytelling engine 120 is configured to process the structured storytelling data 112 to generate scene sequencing 122 and narration and branching logic 124 for the immersive data story. In some embodiments, the scene sequencing 122 defines an order in which scenes, events, or narrative stages are presented, and the narration and branching logic 124 defines narrative content and transition logic that can adapt based on one or more user interactions 126. In some embodiments, the storytelling engine 120 is configured to provide a guided mode in which the scene sequencing and the narration are presented according to a predefined narrative progression. In some embodiments, the storytelling engine 120 is configured to provide a free exploration mode in which a user selectively navigates among spatial locations represented in the immersive data story

The rendering engine 130 is configured to render, based on the structured storytelling data 112 and the one or more three-dimensional models 114, visual content for the immersive data story. As further illustrated in FIG. 1, the rendering engine 130 includes texture baking and decimation 132. In some embodiments, texture baking and decimation 132 are used to optimize one or more three-dimensional models for real-time presentation while preserving visual fidelity. In some embodiments, the rendering engine 130 is configured to render one or more spatial markers anchored to corresponding spatial locations in the location-specific immersive scene.

As further illustrated in FIG. 1, the user interactivity controls module 140 includes gesture-based controls 142 and multisensory feedback 144. In some embodiments, the gesture-based controls 142 are configured to receive gesture inputs from a user interacting through the spatial computing interface (e.g., via spatial computing device 500). In some embodiments, the user interactivity controls module 140 is further configured to receive gaze inputs and voice commands, and to provide corresponding user interaction to the storytelling engine 120 and the rendering engine 130. In this way, the storytelling engine 120 can adapt the scene sequencing 122 and the narration and branching logic 124 based on the user interaction, and the rendering engine 130 can update rendered content responsive to the user interaction.

In some embodiments, the multisensory feedback 144 includes spatial audio, haptic feedback, or other feedback presented through the spatial computing interface during playback of the immersive data story. The spatial computing interface thus enables a user to access and interact with the immersive data story, while the data processing module 110, the storytelling engine 120, the rendering engine 130, and the user interactivity controls module 140 cooperate to support presentation of a macro-level overview and one or more location-specific immersive scenes in a spatial computing environment. For example, in some embodiments, the user interactivity controls module 140 is configured to detect a gaze directed to a selected one of the one or more spatial markers and, responsive to selection of the selected one of the one or more spatial markers, to cause the transition between the macro-level overview and the location-specific immersive scene corresponding to the selected one of the one or more spatial markers. In some embodiments, the user interactivity controls module 140 is configured to receive a voice command specifying a named location represented in the immersive data story and to cause navigation to the location-specific immersive scene corresponding to the named location.

In some embodiments, the disclosed system improves synchronization of multiple presentation layers by maintaining common structured storytelling data for both a macro-level overview and one or more location-specific immersive scenes. The rendering engine 130 can use the common structured storytelling data and one or more three-dimensional models to generate dashboard content, chart content, spatial markers, and immersive scene content from a shared underlying data representation. By deriving overview content and immersive content from a common data foundation and by applying narrative transition logic tied to scene objects, the disclosed system can reduce inconsistencies between dashboard updates and three-dimensional scene updates, preserve spatial context during transitions, and improve reliability of interactive drill-down operations from overview content into localized immersive presentations.

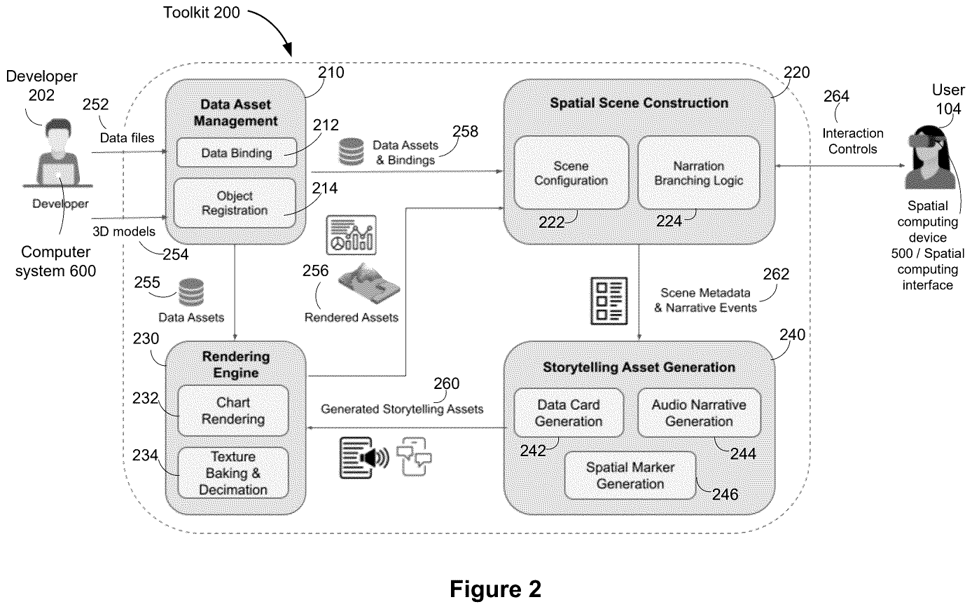

FIG. 2 illustrates a toolkit 200 for generating immersive data stories for presentation on a spatial computing device 500, in accordance with some embodiments. The toolkit 200 can be implemented using the visionOS SDK, incorporating SwiftUI, RealityKit, and ARKit for 2D and 3D rendering, gesture recognition, and gaze tracking

The toolkit 200 includes a data asset management module 210, a spatial scene construction module 220, a rendering engine 230, a storytelling asset generation module 240, and a spatial computing interface (e.g., implemented via spatial computing device 500).

A developer 202 provides data files 252 and one or more three-dimensional models 254 to the toolkit 200. The data files 252 can include structured data and storytelling assets. In some embodiments, the data asset management module 210 is configured to receive the data files 252, including the structured data and storytelling assets, and the one or more three-dimensional models 254, and to bind the structured data to visual assets associated with the immersive data story.

The data asset management module 210 includes a data binding component 212 and an object registration component 214. In some embodiments, the data asset management module 210 generates and/or updates a SQLite database for structured data storage, organizing data attributes such as location, time, and event metadata into queryable schemas. In some embodiments, the data binding component 212 establishes bindings between data fields of the structured data and corresponding visual assets or scene objects, thereby enabling persistent linkages between underlying data and rendered content. This binding enables automatic real-time updates when users interact with data-driven elements in the HMD environment. In some embodiments, the object registration component 214 registers objects for inclusion in a scene graph and associates the objects with identifiers, spatial metadata, temporal sequencing information, and/or interaction handlers. For example, during asset import, the object registration component 214 registers objects with the scene graph through an internal object registry system. This registry supports spatial indexing and semantic tagging of 3D objects, allowing for efficient runtime retrieval, interaction, and event triggering based on user gaze or gesture inputs, a technique commonly employed in Augmented Reality (AR) or Virtual Reality VR) applications. More concretely, data-bound assets are automatically augmented with unique identifiers, position and orientation metadata, and interaction affordances. The data asset management module 210 outputs data assets and bindings 258.

With continued reference to FIG. 2, the data assets and bindings 258 are passed to a spatial scene construction module 220 which orchestrates the dynamic configuration of immersive scenes and the branching logic of narrative events within the spatial storytelling environment. The spatial scene construction module 220 is configured to generate scene objects, spatial metadata, temporal sequencing, and interaction handlers defining a scene graph for the immersive data story. In the example of FIG. 2, the spatial scene construction module 220 includes a scene configuration component 222 and a narration branching logic component 224. In some embodiments, the scene configuration component 222 arranges scene objects and presentation elements into a coherent spatial layout based on the structured data, the data assets and bindings 258, and the rendered assets 256. In some embodiments, the narration branching logic component 224 defines narrative transition logic, branching conditions, and event sequencing for guided walkthrough mode, exploration mode, or both. At runtime, the spatial scene construction module 220 parses the registered 3D objects and data assets to construct a coherent and semantically meaningful spatial layout. Each object or asset is associated with metadata such as spatial coordinates, orientation, and temporal sequencing obtained from the data asset management module 210. The spatial scene construction module 220 outputs scene metadata and narrative events 262, which represent context used to coordinate scene transitions and context-specific narrative content.

The storytelling asset generation module 240 is configured to generate contextual narrative assets based on the structured data and the scene graph. In some embodiments, the storytelling asset generation module 240 produces immersive storytelling elements such as data cards, audio narratives, and spatial markers, based on the metadata and spatial scene construction.

In some embodiments, the toolkit 200 converts textual narratives from the data files into audio narratives using OpenAI's Text-to-Speech API, where the developer can customize the voice characteristics via an input prompt in the toolkit. Scene configuration is driven by scene metadata and narrative event triggers attached to data elements. When a user 104 interacts with a spatial marker (e.g., via gaze, gesture), the storytelling asset generation module 240 updates the scene context by revealing new assets, repositioning entities, or triggering animations based on the branching structure defined in the narrative logic. Scenes are organized through the logical grouping of assets, supporting scalable spatial storytelling where localized details can be progressively disclosed within broader narrative arcs. Transitions between narrative stages are managed through a state machine that encodes scene states, transition conditions, and animation sequences.

In other words, the toolkit 200 does not merely display a fixed sequence of scenes. Instead, the toolkit 200 defines a formal control structure for how the immersive story progresses from one narrative stage to another, and that control structure can respond to user interaction. At a high level, the state machine is the mechanism that organizes the story into discrete scene states. A scene state can correspond, for example, to a particular dashboard view, a particular terrain view, a particular city-focused view, or a deeper localized immersive scene. Each state can have its own associated assets, such as displayed models, charts, narration, markers, environmental audio, and interaction options. In some embodiments, the toolkit 200 defines the conditions under which the system moves from one scene state to another. Those conditions can be tied to user actions, such as selecting a spatial marker, gazing at an object, performing a gesture, or issuing a voice command. They can also be tied to narrative events, such as the completion of narration, arrival at a timeline point, or activation of a walkthrough step. The system does not transition arbitrarily; instead, it follows predefined logic that determines when a next scene becomes active. The transition is not just a logical jump from one state to another, but can include visual and auditory presentation behavior associated with the transition. For example, when the user selects a location, the system may reveal new assets, reposition entities, animate troop movement, update graphs, trigger narration, or enter a more immersive scene.

Developers can specify branching points in the toolkit 200 where users'interactions dynamically alter the exploration of the underlying data story. Accordingly, instead of every user seeing exactly the same narrative sequence, the developer (e.g., author) can encode decision points. At those points, different user interactions can lead to different next states or different narrative content. For example, one user may continue in a guided walkthrough, while another may select a city marker to inspect localized details, or may use voice input to jump to a named location. The branch is therefore not random; it is authored in advance, but the actual path taken depends on runtime interaction.

Referring to FIG. 2, the storytelling asset generation module 240 receives the scene metadata and narrative events 262. The storytelling asset generation module 240 includes a data card generation component 242, an audio narrative generation component 244, and a spatial marker generation component 246. In some embodiments, the data card generation component 242 generates one or more data cards associated with respective locations, scene objects, or events represented in the immersive data story. In some embodiments, the audio narrative generation component 244 generates one or more audio narratives corresponding to narrative stages, locations, or events. In some embodiments, the spatial marker generation component 246 generates one or more spatial markers that may be anchored to corresponding spatial locations and may be selectable to reveal context-specific narrative content or trigger a corresponding localized immersive presentation. The storytelling asset generation module 240 outputs generated storytelling assets 260, which can be rendered for interactive presentation.

The rendering engine 230 is configured to process visual content associated with the immersive data story. In some embodiments, the rendering engine 230 receives the data assets 255 and the generated storytelling assets 260, and generates rendered assets 256 for use in constructing a macro-level overview and one or more location-specific immersive scenes. In some embodiments, the rendered assets 256 and the generated storytelling assets 260 cooperate to support synchronized presentation of overview content and localized immersive content. The rendering engine 230 processes these assets and visual models to generate 2D charts and dashboards, along with rendering 3D models and immersive scenes.

As further illustrated, the rendering engine 230 includes a chart rendering component 232 and a texture baking and decimation component 234. In some embodiments, the chart rendering component 232 generates one or more data charts or dashboards associated with the immersive data story. In some embodiments, the texture baking and decimation component 234 optimizes the one or more three-dimensional models by reducing rendering load while preserving visual fidelity for real-time presentation in a spatial computing environment.

For example, in some embodiments, the rendering engine 230 generates a high-resolution 3D model using sculpting techniques, procedural modeling, photogrammetry, or other acquisition methods. Such high-resolution models may include a dense polygonal mesh comprising a large number of vertices, edges, and faces, thereby capturing fine surface details including micro-geometry, curvature variations, and surface irregularities. In some embodiments, the rendering engine 230 generates a reduced-complexity representation of the high-resolution model. In some embodiments, this is achieved via the texture baking and decimation component 234 by using a decimation process that reduces polygon count by selectively collapsing edges, removing vertices, and re-triangulating surfaces while preserving a target approximation of the original geometry. For example, decimation reduces the polygon count of 3D models, allowing for dynamic level-of-detail adjustments, which is particularly useful for rendering models in immersive environments. In some embodiments, the decimation process prioritizes preservation of salient geometric features, including silhouette edges, high-curvature regions, and visually significant contours. Error metrics may be employed to evaluate deviation between the simplified model and the original high-resolution model. In some embodiments, the texture baking and decimation component 234 generates one or more texture maps by projecting information from the high-resolution model onto the simplified model. In some embodiments, a ray-casting or projection technique is employed, wherein rays are traced from points on the simplified model toward corresponding regions of the high-resolution model to capture surface detail. Stated another way, texture baking precomputes lighting, shadows, and material properties onto a 2D texture map, eliminating the need for real-time lighting calculations and further improving performance. In some embodiments, the rendered assets 256 are provided to the spatial scene construction module 220.

As further illustrated in FIG. 2, interaction controls 264 are provided between the spatial scene construction module 220 and the spatial computing device 500. In some embodiments, the interaction controls 264 receive gaze inputs, gesture inputs, voice commands, or combinations thereof from a user interacting through the spatial computing interface 500 and provide corresponding user interaction for controlling scene transitions, narrative progression, and presentation of contextual narrative assets. Thus, FIG. 2 illustrates the various modules of the toolkit 200 cooperating to bind structured data to visual assets, construct a scene graph, generate contextual narrative assets, and render an immersive data story for interactive playback through the spatial computing device 500.

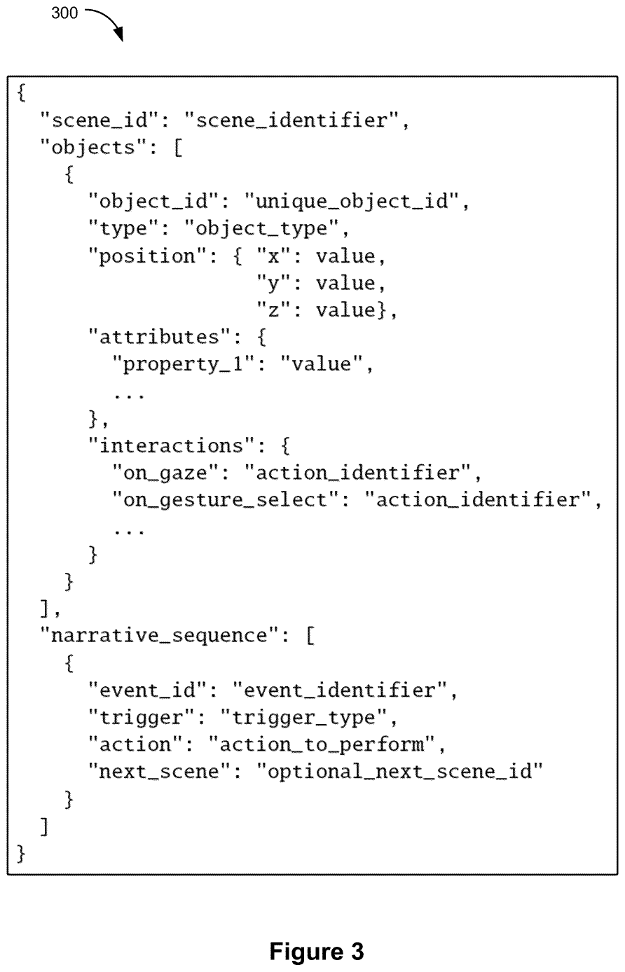

FIG. 3 shows a format of the spatial scene construction graph 300 generated by the toolkit 200, in accordance with some embodiments. Here, each scene object encodes an identifier, type, spatial position, attributes, and interaction handlers that map user actions to narrative events and scene transitions.

In some embodiments, the spatial scene construction graph 300 is generated by the spatial scene construction module 220 and encodes scene objects, spatial metadata, temporal sequencing, and interaction handlers defining a scene graph. As shown in FIG. 3, the spatial scene construction graph 300 may be represented as a structured data object including a scene identifier field, shown as “scene_id,” an objects field, shown as “objects,” and a narrative sequence field, shown as “narrative_sequence.” In some embodiments, the scene identifier field stores an identifier for a corresponding scene, while the objects field stores a collection of scene objects associated with the scene and the narrative sequence field stores narrative events used to coordinate scene transitions and context-specific narrative content

Within the objects field, FIG. 3 shows that a respective scene object may include an object identifier field, shown as “object_id,” a type field, shown as “type,” a position field, shown as “position,” an attributes field, shown as “attributes,” and an interactions field, shown as “interactions.” In some embodiments, the object identifier field stores a distinct identifier for the respective scene object, and the type field indicates an object type associated with a spatial visual asset, presentation element, or other scene object represented in the immersive data story. In some embodiments, the position field stores spatial metadata for the respective scene object. As illustrated, the position field may include coordinate values along an x field, a y field, and a z field, thereby specifying a spatial position of the respective scene object within a three-dimensional spatial layout. In some embodiments, the attributes field stores one or more properties bound to the respective scene object from structured event data or other structured storytelling data. The interactions field stores interaction handlers that map user actions to narrative events and scene transitions.

FIG. 3 further shows example interaction handlers including an on-gaze field, shown as “on_gaze,” and an on-gesture-select field, shown as “on_gesture_select.” In some embodiments, the on-gaze field specifies an action identifier to be invoked in response to a gaze input directed to the respective scene object, and the on-gesture-select field specifies an action identifier to be invoked in response to a gesture input selecting the respective scene object. In some embodiments, additional interaction handlers may be provided for other user actions, including voice commands. By associating the respective scene object with the interaction handlers, the spatial scene construction graph supports interaction-linked presentation data that associates the respective scene object with context-specific narrative content and, in some embodiments, a corresponding localized immersive presentation. For example, user interaction with a spatial marker or other scene object may reveal contextual narrative assets, reposition entities, trigger animations, or initiate a scene transition according to narrative transition logic.

Within the narrative sequence field, FIG. 3 shows that a respective narrative event may include an event identifier field, shown as “event_id,” a trigger field, shown as “trigger,” an action field, shown as “action,” and a next scene field, shown as “next_scene.” In some embodiments, the event identifier field stores an identifier for a narrative event, the trigger field indicates a trigger type associated with the narrative event, and the action field specifies an action to be performed when the trigger type is satisfied. In some embodiments, the next scene field identifies a subsequent scene to which the immersive data story transitions after performance of the action, and the next scene field may be optional for a terminal event or for an event that does not cause a scene transition. In some embodiments, the narrative sequence field implements at least a portion of a state machine that encodes scene states, transition conditions, and animation sequences for guided walkthrough mode, exploration mode, or both. Accordingly, the spatial scene construction graph of FIG. 3 provides a machine-readable format through which the toolkit can arrange scene objects into a coherent spatial layout and coordinate narrative progression within the spatial computing environment.

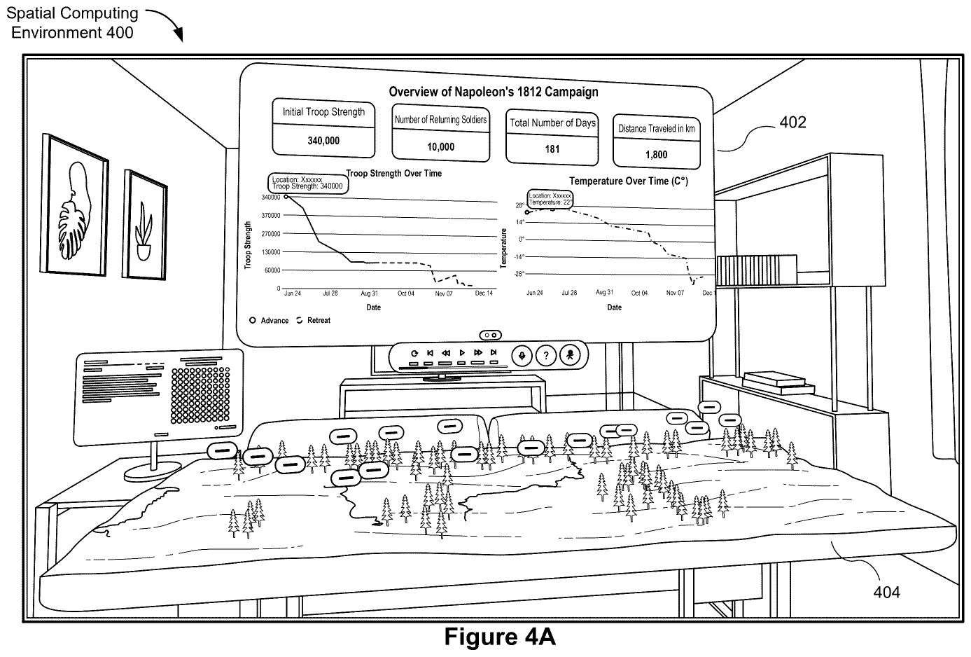

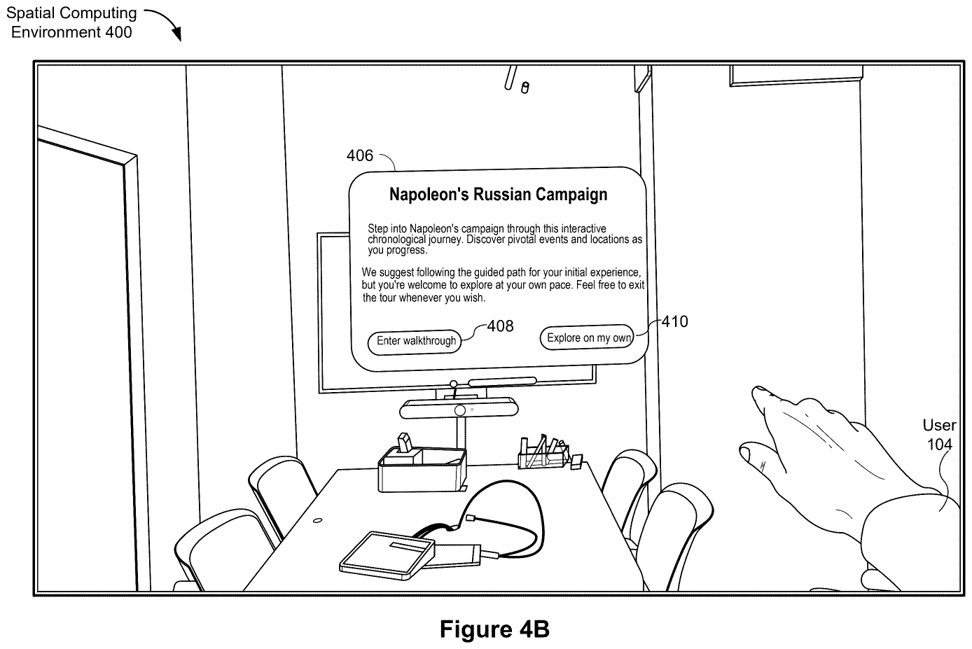

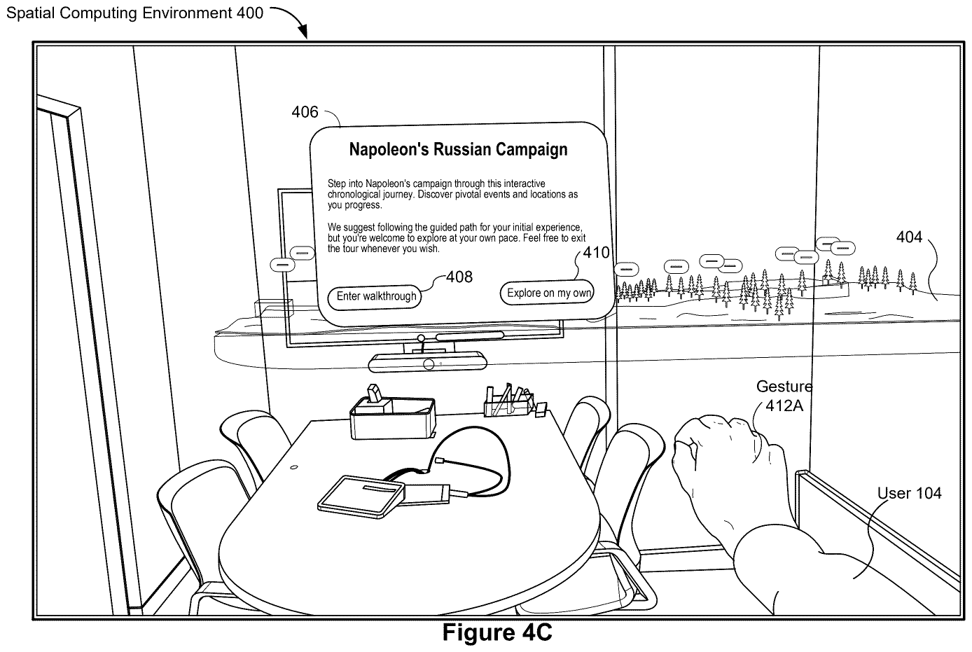

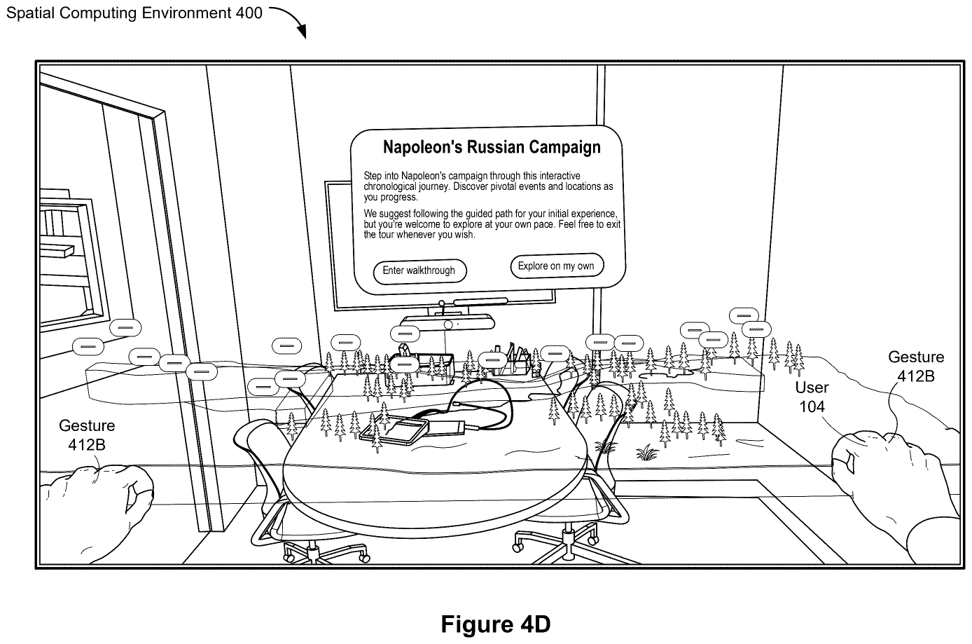

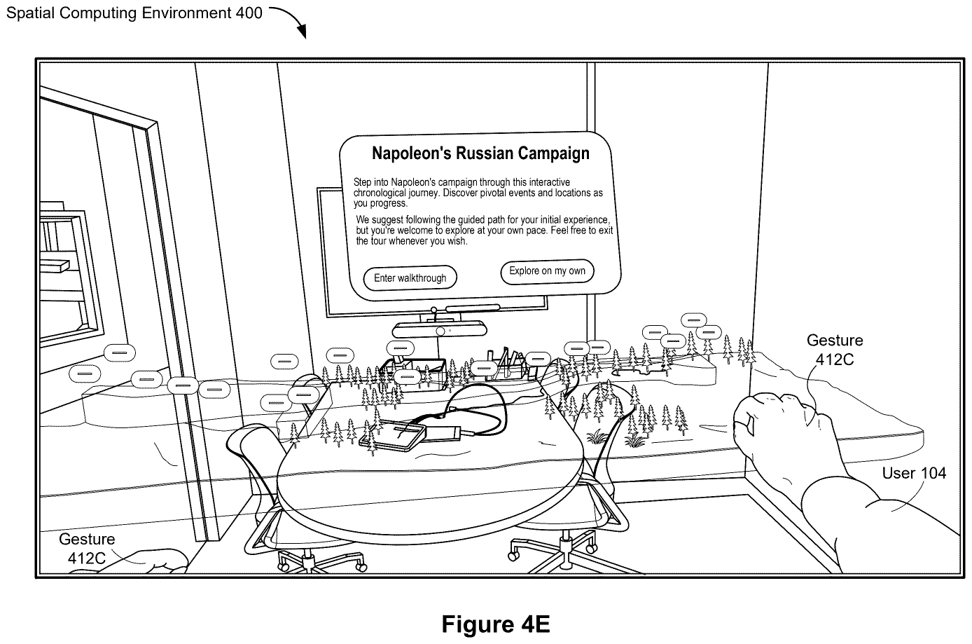

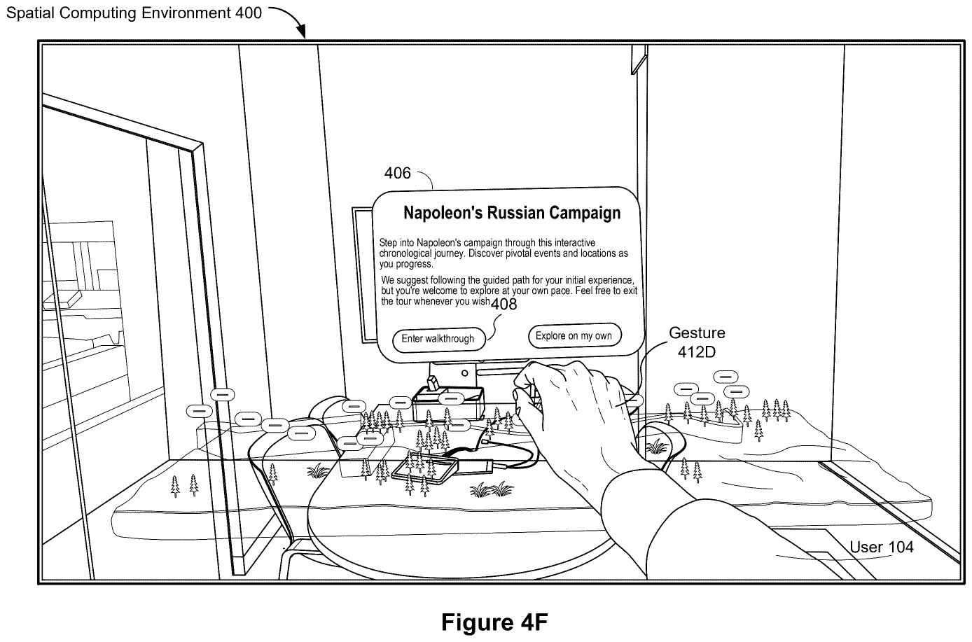

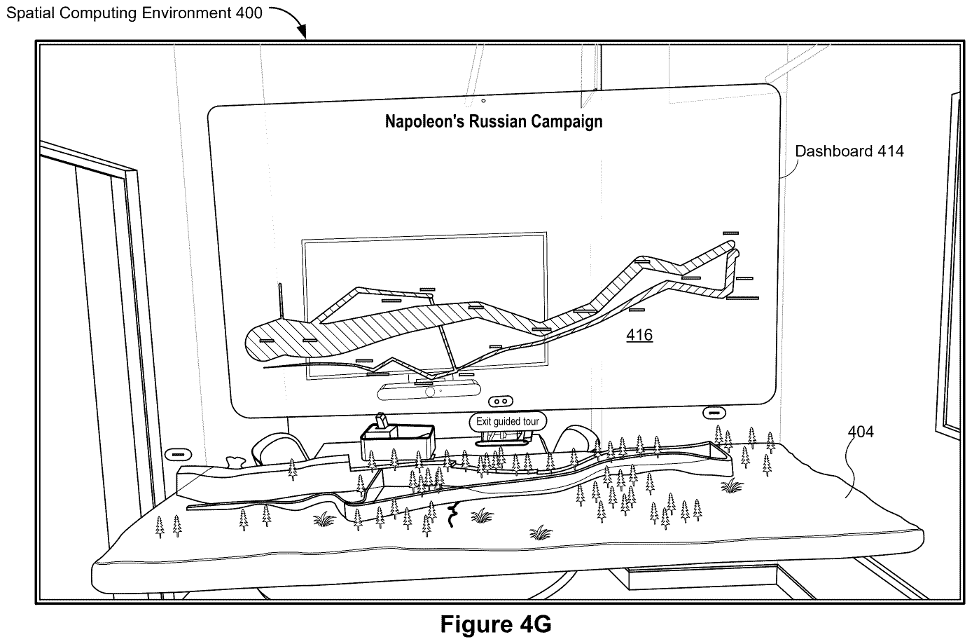

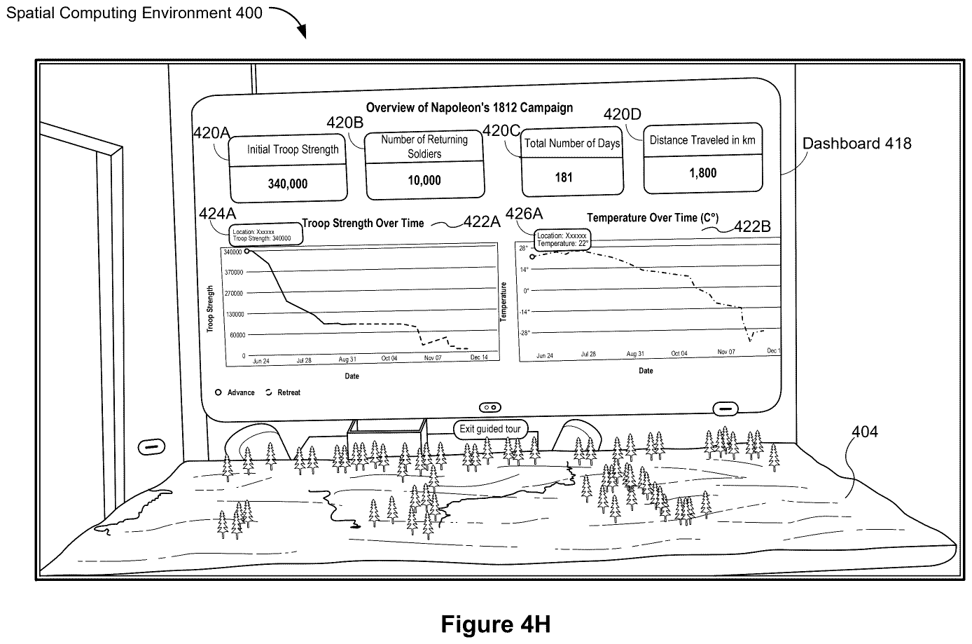

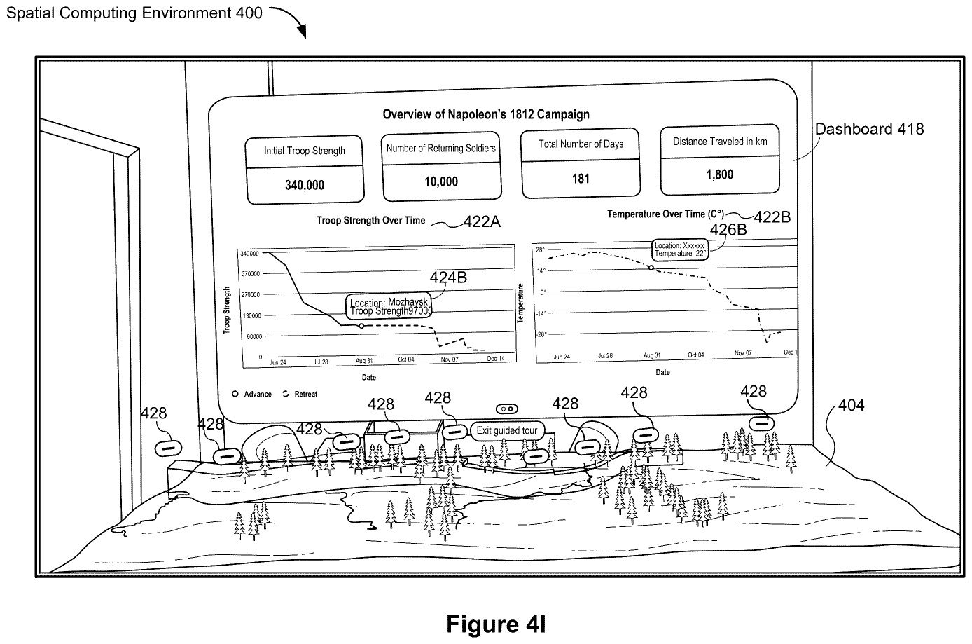

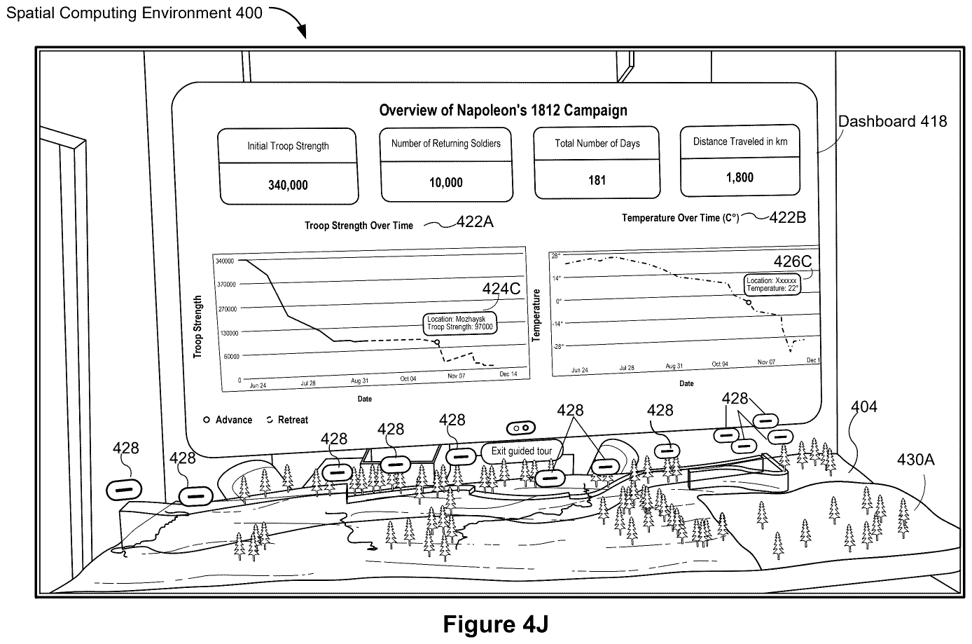

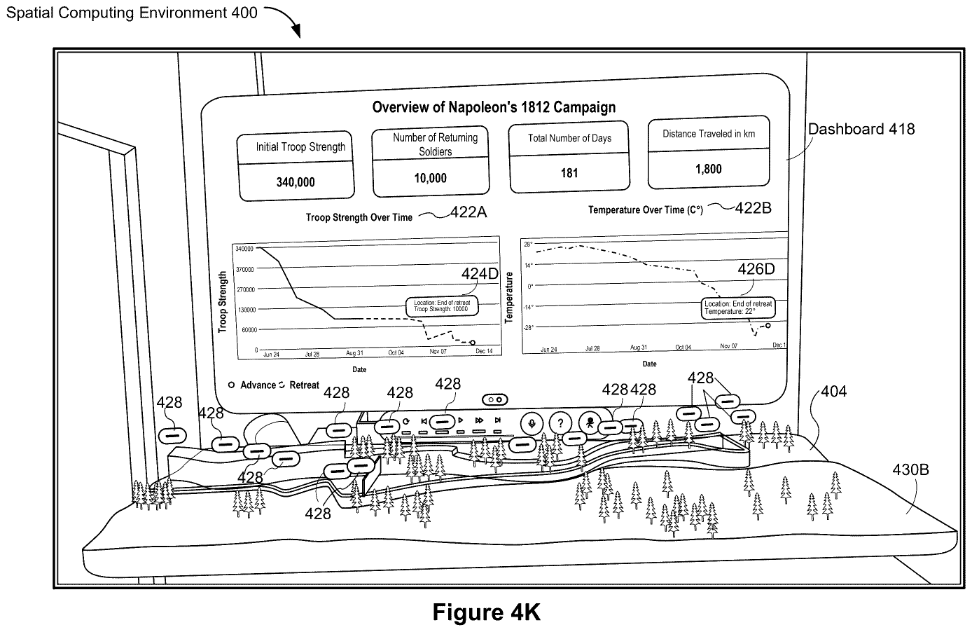

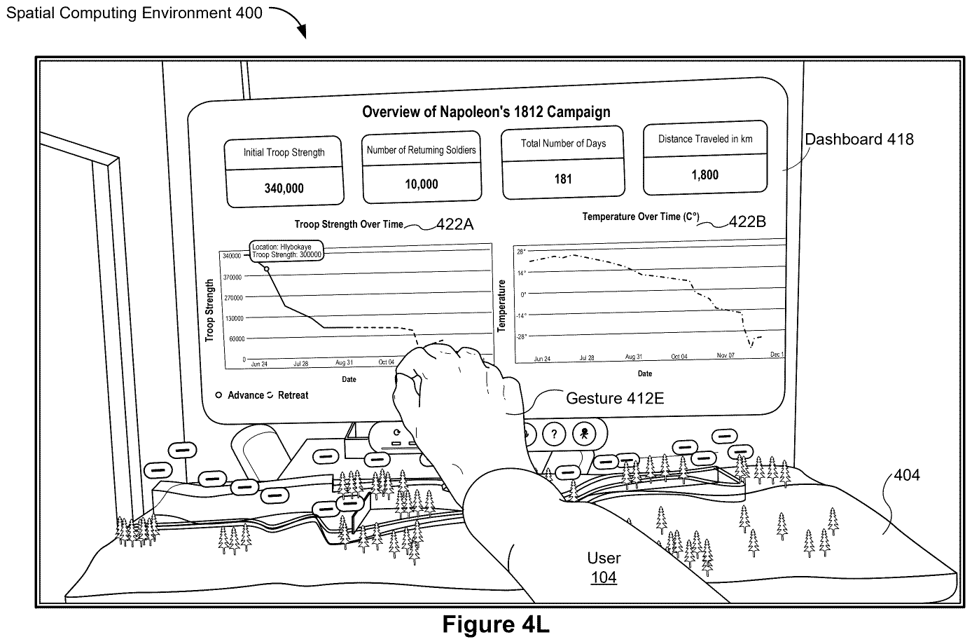

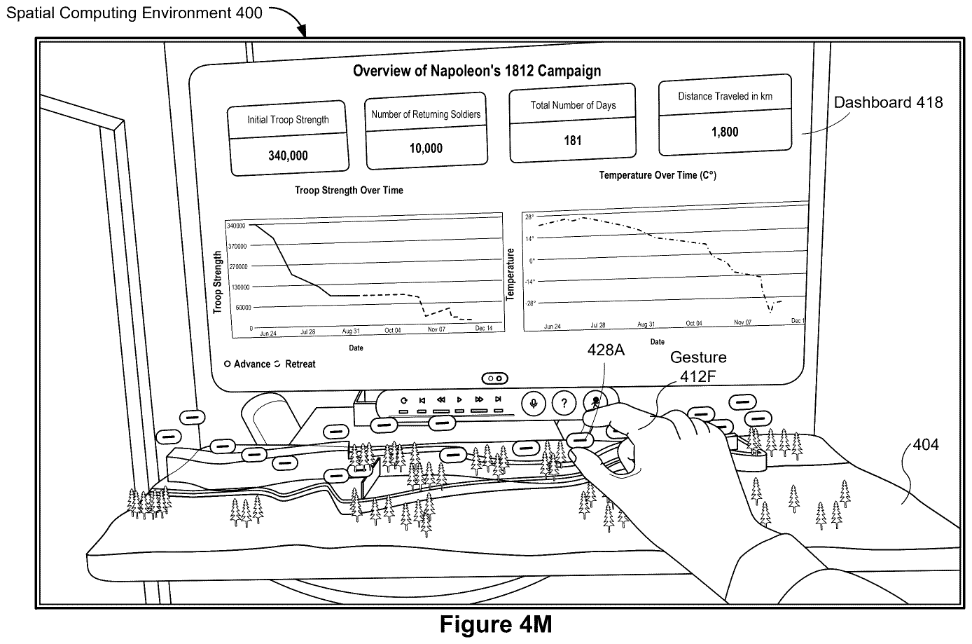

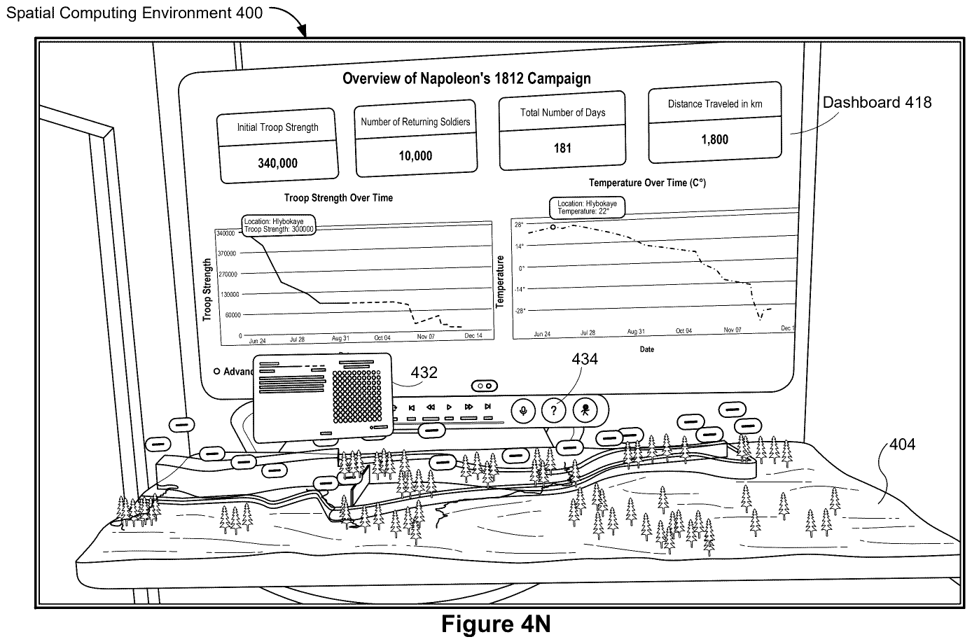

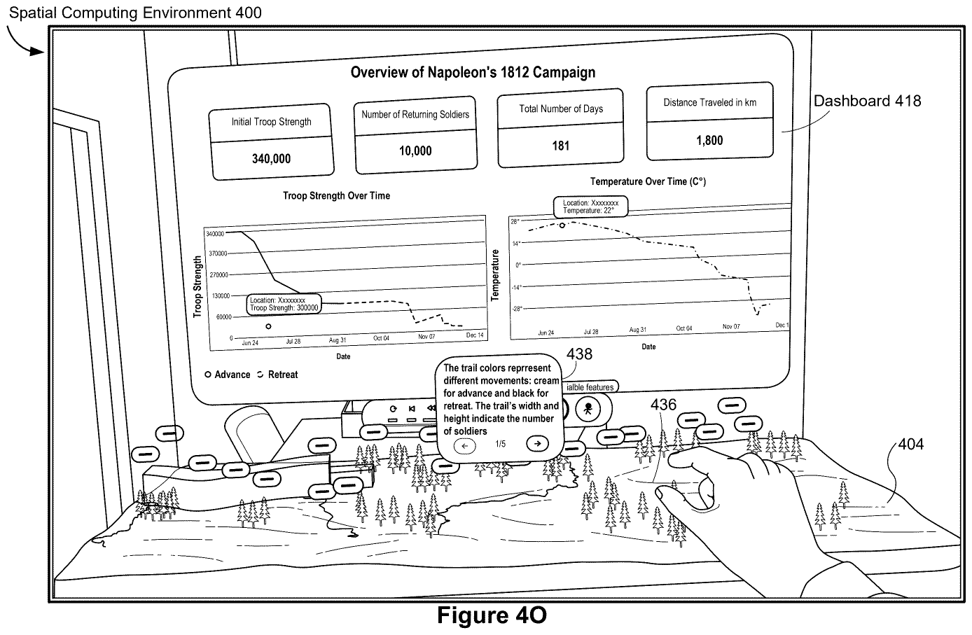

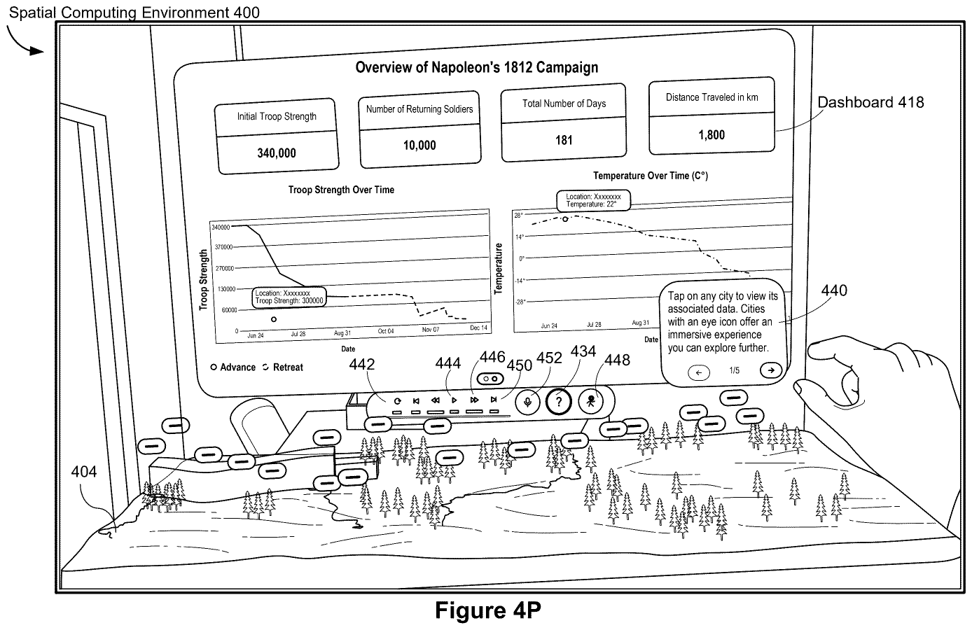

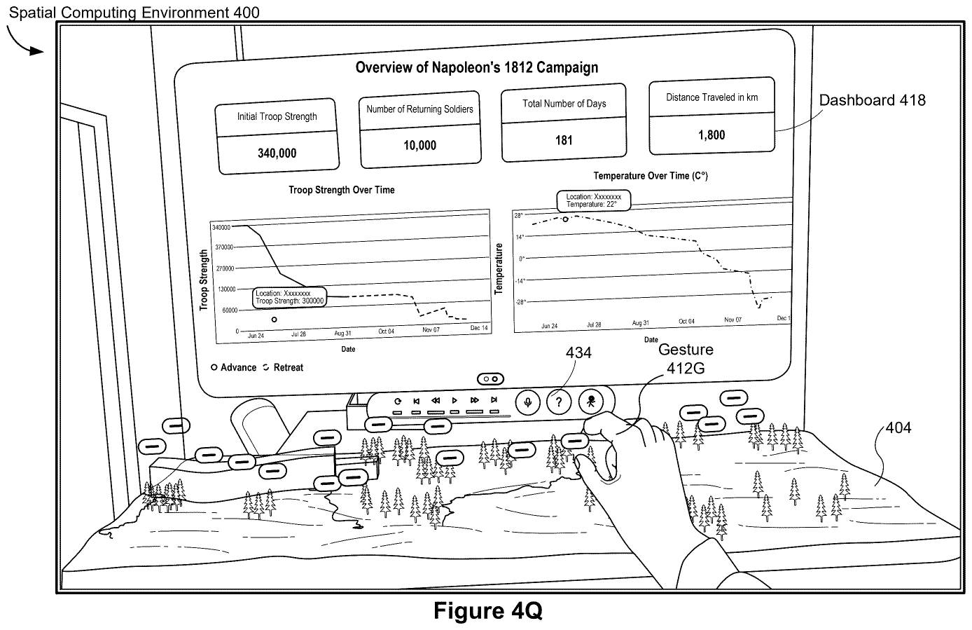

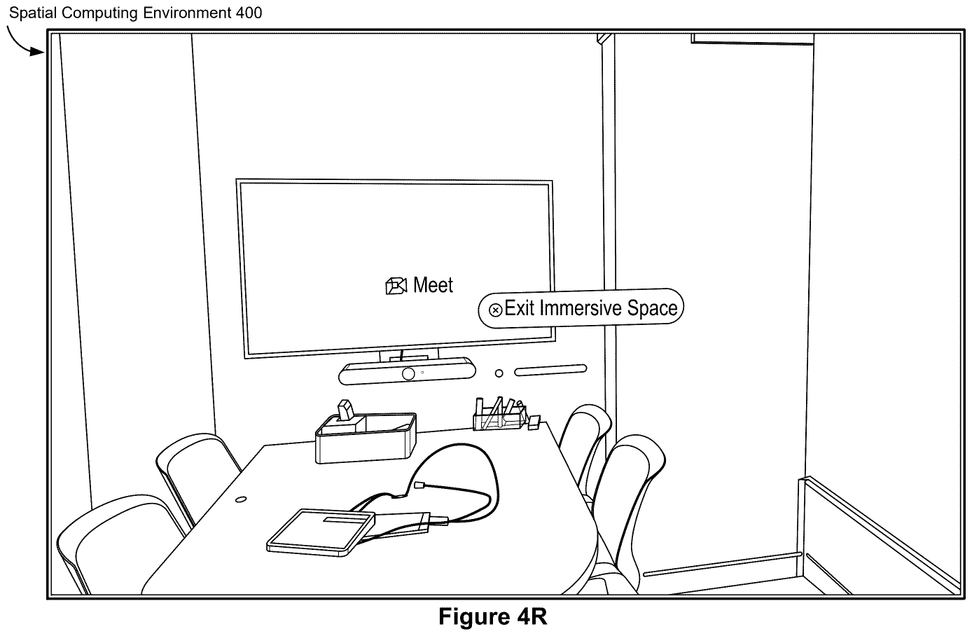

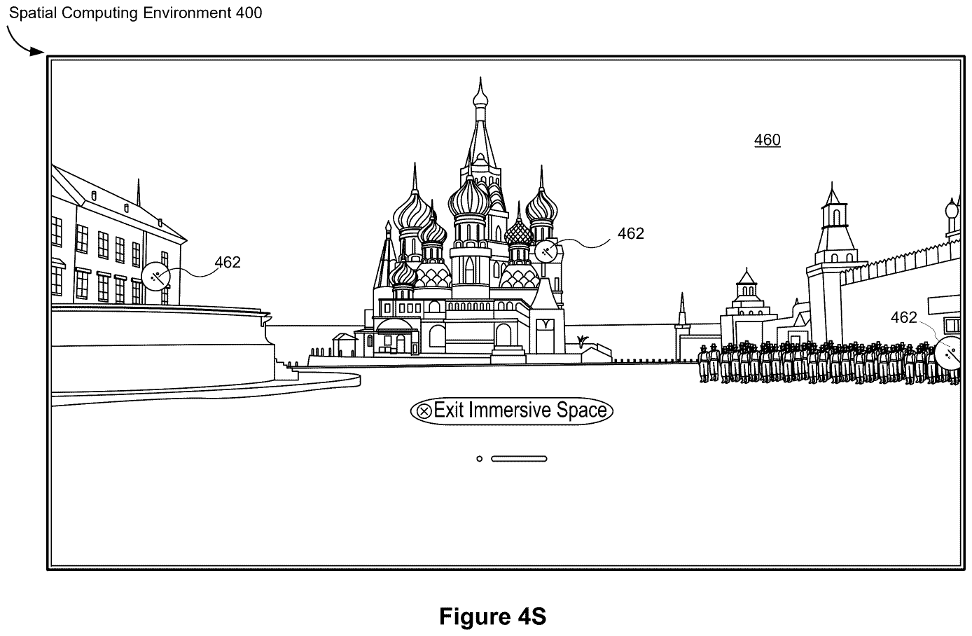

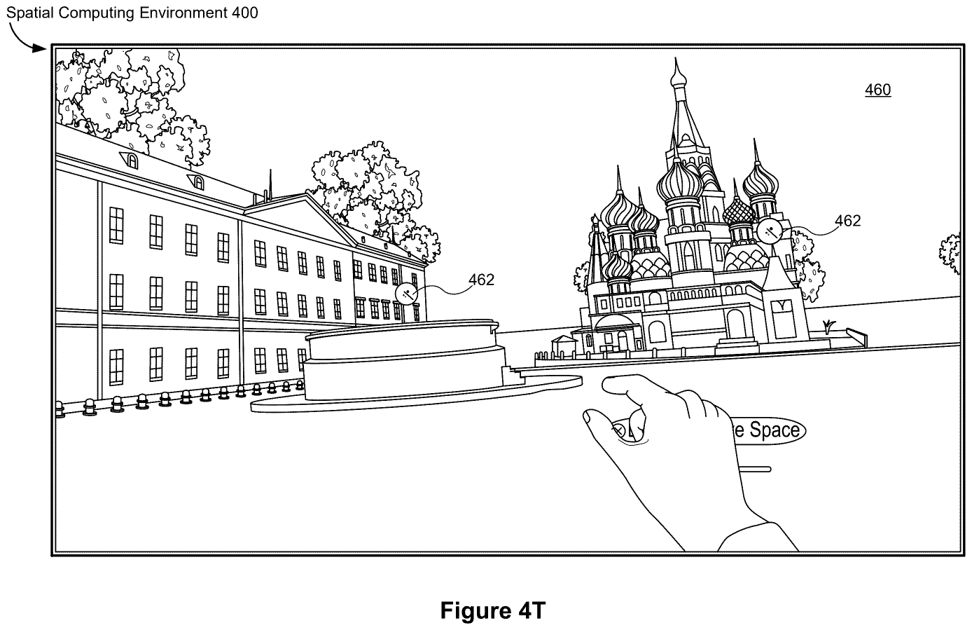

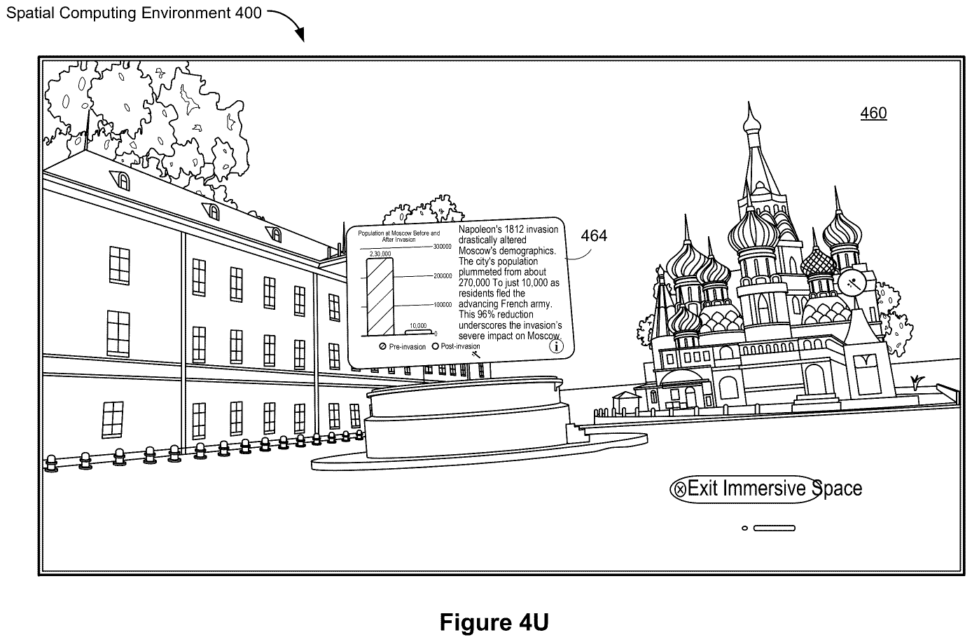

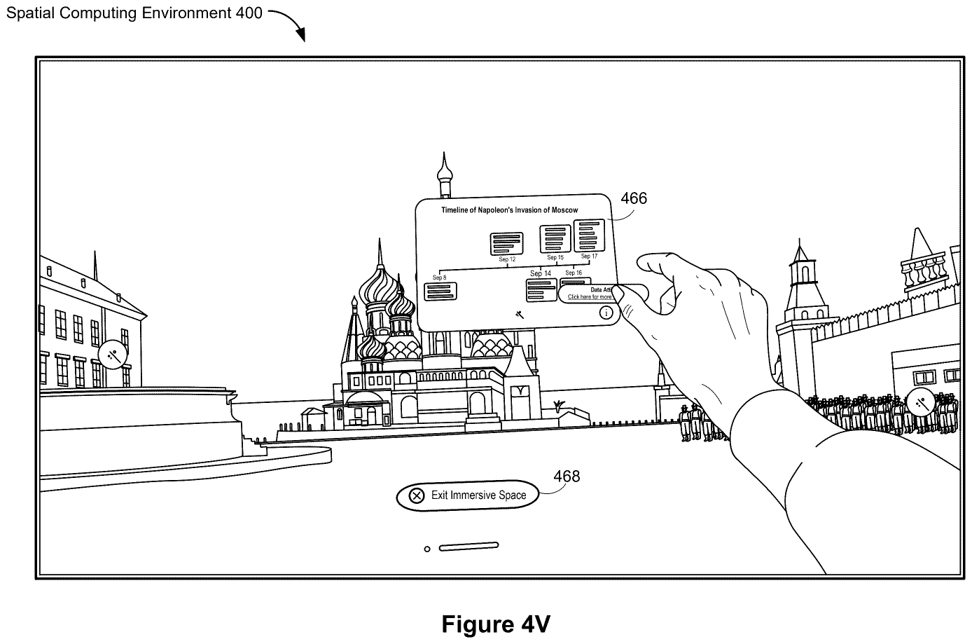

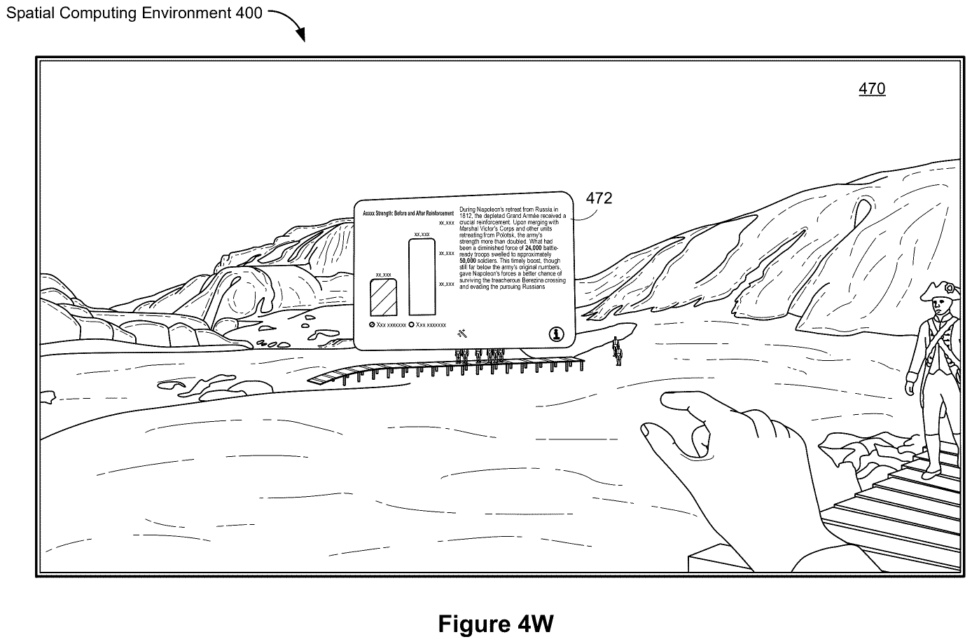

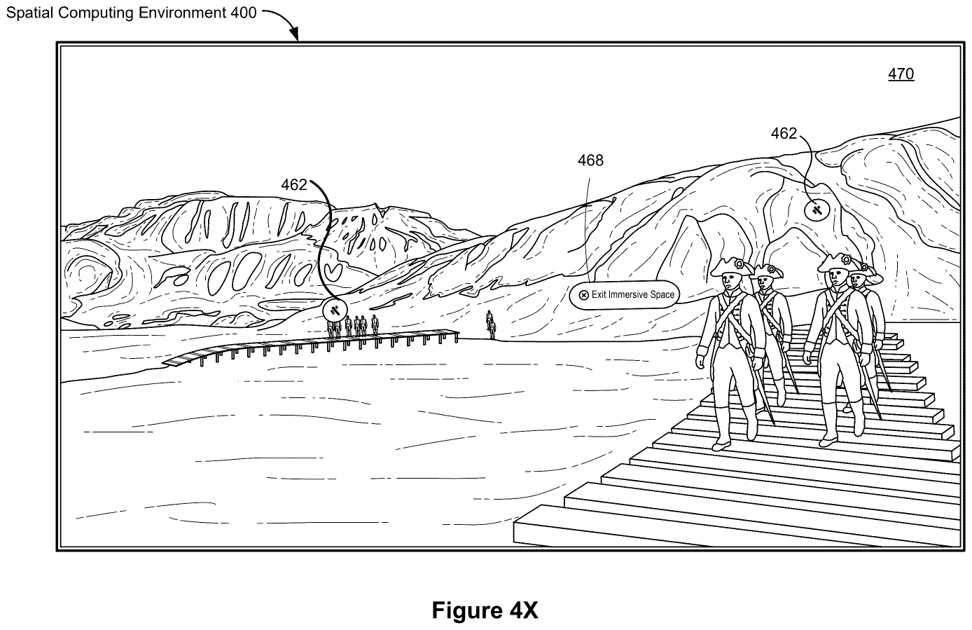

To demonstrate the capabilities of the toolkit 200, the inventors employed the toolkit 200 for developing a well-known historical data narrative—Minard's visualization of Napoleon's march to Moscow (hereinafter referred to as “Minard application”). FIGS. 4A to 4X are screenshots illustrating a spatial computing environment 400, from the user's perspective within the spatial computing interface 530 while the user interacts with the spatial computing device 500.

At a high level, FIGS. 4A to 4X show that the framework 200 presents the historical narrative through two coordinated views. FIG. 4A shows the spatial computing environment 400 includes a dashboard 402 and a 3D terrain model 404, each mapping to specific modules within the toolkit architecture. The dashboard 402 presents an aggregated overview of the data comprising troop size, temperature, and historical milestones. The 3D terrain model 404 provides a detailed, spatially grounded view of the historical narrative. The data asset management module 210 supplies structured data bindings to the visual elements, while the spatial scene construction module 220 and the rendering engine 230 instantiate troop movement paths, terrain features, and data overlays. The figures illustrate that the dashboard 402 and the terrain view 404 are synchronized so that interaction with one affects the other. Narrative sequencing and contextual annotations within the terrain are orchestrated through the storytelling asset generation module 240, providing users with location-specific insights as they progress through the narrative experience. For example, as will be described in further detail below, as the narration progresses, the 3D terrain model 404 updates to reflect troop movement, changing geography, and later winter conditions. The associated graphs are synchronized with the narrative so that troop strength, location, and temperature evolve over time together. By the end of this sequence, the user is invited to continue exploring the story interactively.

FIGS. 4B through 4E show direct manipulation of the 3D representation. In FIG. 4B, the spatial computing environment 400 displays a data card 406 that introduces the user to Napoleon's Russian campaign. The data card 406 includes a walkthrough option 408 that, when selected, activates a guided walkthrough mode. The data card 406 includes a self-exploration option 410 that, when selected, enables the user to explore the immersive data narrative on their own. FIG. 4C shows the user 104 can move the 3D terrain model 404 with one hand, via gesture 412A. FIG. 4D shows the user 104 can scale the 3D terrain model 404 with two-handed gestures 412B, and FIG. 4D shows the user 104 can rotate it with two-handed gestures 412C rotate it with two-handed gestures. These figures demonstrate the gesture-based interaction capabilities of the framework.

FIG. 4F shows the user 104 gazing at the walkthrough option 408 (e.g., “Enter walkthrough” icon) and selecting the option 408 using a gesture 412D that involves tapping two of the user's fingers. This selects the walkthrough mode. In some embodiments, the walkthrough mode includes an overview presentation which gives the user some background on Napoleon's Russian Campaign. In some embodiments, when the walkthrough mode is selected, the spatial computing device 500 begins an audio-guided historical narrative of Napoleon's campaign. The following is a text transcript of the audio narrative experienced by the user in the walkthrough mode, with visuals synchronized to the audio narrative as described below.

The audio narrative begins with the spatial computing environment 400 displaying the 3D terrain model 404 with a dashboard 414 that includes a map, as shown in FIG. 4G. The audio narrative describes: “Welcome to Minard on VisionOS, where we journey back to one of history's most infamous military campaigns—Napoleon's ill-fated invasion of Russia. Picture this: a vast cold expanse, where the fate of an empire was written in the unforgiving snows of 1812. Through the groundbreaking visualization by Charles Minard, we'll witness the harrowing tale of Napoleon's grand army, brought to life in a way you've never seen before. Prepare to immerse yourself in this data-driven narrative that vividly captures the triumphs, struggles, and ultimate tragedy of this historic campaign.”

The audio narrative continues while the spatial computing environment 400 transitions to displaying a dashboard 418 that includes data cards 420A to 420D and charts 422A and 422B, as shown in FIG. 4H. The audio narrative recites: “Let's begin by setting the stage and some essential background. Napoleon Bonaparte's 1812 invasion of Russia stands as one of history's most disastrous military campaigns. With ambitions to cripple Britian's economy by forcing Tzar Alexander I to cut off trade, Napoleon marched over 340,000 soldiers into Russia, on June 20th. But the Russians had a different plan. They retreated, luring the French deeper into unforgiving terrain, destroying everything in their wake. Napoleon's retreat from Moscow in October 1812, turned into a nightmare of epic proportions. The Grande Armée, once a mighty force, now battled against brutal cold, crippling supply shortages, and relentless Russian assaults. The crossing at the Berezina river became a desperate fight for survival. As winter tightened its grip, Napoleon made the fateful decision to abandon his army in December, plunging morale to new lows. By the time the remnants of his once great force stumbled across Nieman river in mid-December, only about 10,000 of the original 340,000 men remained, many barely clinging to life, wounded, frostbitten.” Note that while this narrative is played, the spatial computing environment 400 synchronously updates the dashboard 418 and the 3D terrain model 404, as shown in the transition from FIG. 4H→FIG. 4I→FIG. 4J→FIG. 4K. In these figures, a marker in the chart 422A depicting troop strength over time is updated from marker position 424A in FIG. 4H, to marker position 424B in FIG. 4I, to marker position 424C in FIG. 4J, to marker position 424D in FIG. 4K. Each of the marker positions 424A to 424D includes an identification of the corresponding geographical location and the number of troops in each of these geographical locations. FIGS. 4H to 4K also depict that a marker in the chart 422B, corresponding to temperature over time, is updated from marker position 426A in FIG. 4H, to marker position 426B in FIG. 4I, to marker position 426C in FIG. 4J, to marker position 426D in FIG. 4J. Each of the marker positions 426A to 426D includes an identification of the corresponding geographical location and the temperature in each of these geographical locations. The 3D terrain model 404 is synchronously updated with the audio narrative and the dashboard 418, to visually depict movement of the troops marching across different regions of Russia. The movement of the troops is time-synchronized with the chart 422A showing troop strength over time, with the chart 422B showing temperature over time, and with spatial markers 428 corresponding to different geographical locations in Russia. In some embodiments, the spatial markers 428 are anchored to corresponding spatial locations in the location-specific immersive scene. In FIG. 4J, the 3D terrain model 404 includes region 430A that is rendered to simulate an accumulation of snow on exposed surfaces. The transition from FIG. 4J to FIG. 4K shows the region 430A is expanded to region 430B, to simulate an increase in the accumulation of snow due to falling temperatures.

In some embodiments, the rendering engine 130 and the storytelling engine 120 cooperatively maintain temporal synchronization between chart updates, scene-object updates, narration output, and environmental audio output. For example, advancement of a narrative state can trigger coordinated updating of a dashboard element, repositioning or highlighting of a scene object in a three-dimensional environment, and playback of a corresponding narration segment or environmental audio segment. In some embodiments, machine-coordinated synchronization of these outputs improves consistency of immersive presentation and reduces divergence between concurrently presented visual and audio elements.

With continued reference to the screenshots, FIGS. 4L through 4R show the exploration mode and detail-on-demand interactions. FIG. 4L shows that the user 104 dragging along the chart 422A via gesture 412E. In response to the user interaction, the 3D terrain model 404 updates synchronously in accordance with the user interaction. Similarly, user interaction with the 3D terrain model 404 will also cause the dashboard 418 and charts to be updated synchronously as well. In some instances, the user can obtain information directly from the 3D terrain model 404 by selecting geographical regions directly from the 3D terrain model 404, as illustrated in FIG. 4M, which depicts user selection of spatial marker 428A via gesture 412F. FIG. 4N shows that, in response to the user selection, the spatial computing environment 400 retrieves and renders one or more data cards 432, which are displayed in the spatial computing environment 400. In some embodiments, the spatial computing device 500 also outputs associated narration (e.g., concurrently with displaying the data cards).

FIGS. 4N and 4O show the user select a question mark icon 434 followed by a trail 436 on the 3D terrain model 404. A data card 438 describing the trail is displayed in the spatial computing environment 400. FIG. 4P shows that in some embodiments, in accordance with user selection of the question mark icon 434 followed by the trail 436, a data card 440 is displayed. In some embodiments, while displaying the data card, a narrative is concurrently played back to the user: “The trail colors represent different movements. Tap on any city to view its associated data. Navigate through the campaign, interact with cities using the control panel.”

FIG. 4P illustrates the spatial computing environment 400 display a control panel 442 with functions such as pausing audio (e.g., by pressing the playback button 444), moving to the next city (e.g., by pressing the fast forward button 446), and accessing a guide 448 that explains available interactions. Accordingly, the spatial computing framework 100 also supports non-linear exploration in addition to guided storytelling.

In some embodiments, the control panel 442 includes a “go-to-end” button 450, which starts a start-to-finish animation of the campaign. Here, the user can see the path taken throughout the six months of the invasion, and learn that the key part of the campaign is the temperature change during the retreat, where soldiers died of cold and starvation. The snow on the terrain and code set, and temperature graph also updates in real time. A data card showing the remaining soldiers, the date Napoleon entered the city, as well as a transcript of the narration, can be displayed in the spatial computing environment.

In some embodiments, the immersive data story supports voice recognition. For example, the control panel 442 includes a microphone icon 452 that, when selected, receives one or more verbal inputs from the user, such as “Go to Dorogobuzh.” The algorithm will understand the user's request and, in some instances, output an audio narrative such as “On August 23^{rd}, 1812, 100,000 troops advanced though Dorogobuzh . . . ” and/or display one or more data cards depicting information about the city Dorogobuzh pertaining to Napoleon's invasion of this city. In some embodiments, the spatial computing device 500 navigates to a location-specific immersive scene corresponding to the named location “Dorogobuzh.”

With continued reference to the FIG. 4Q, the narrative may continue with “Now it's your turn to step into history and explore this epic journey for yourself. Want to unlock all the features and dive even deeper? Just tap the question mark icon on the control panel for a quick guide.” FIG. 4Q shows the user tapping on the question mark icon 434 via gesture 412G. FIG. 4R shows the spatial computing environment 400 exiting the walkthrough/exploration mode. FIG. 4S shows the transition of the data story into the immersive space. In some embodiments, as illustrated in FIGS. 4A to 4Q, the spatial computing device 500 operates in a partially immersive mode when the data story is in the walkthrough/exploration mode. In the partially immersive mode, the user can view the contents of the app as well as the surroundings. In other words, the spatial computing device 500 reveals the user's surroundings so the user is aware of their surroundings in the partially immersive mode (e.g., when the data story is in the walkthrough/exploration mode). In some embodiments, when the data story is in the immersive space, the spatial computing device 500 operates in a fully immersive mode, where the spatial computing device 500 does not reveal the user's surroundings to the user.

In some embodiments, the spatial computing device 500 transitions from a walkthrough mode (or exploration mode) to a location-specific immersive scene in response to receiving (e.g., detecting) a gaze input directed to a spatial marker 428. With continued reference to FIG. 4S, the user is “transported” to the Kremlin in Moscow in the immersive data story. FIG. 4S is an immersive scene 460 of the Kremlin. In the data story, the Russians set their own city on fire and fled to weaken the French troops. The user obtain get additional information about this specific event that was not mentioned on the 3D terrain model 404, by selecting any one of the icons 462 depicted in FIG. 4S and FIG. 4T. When clicking on a respective icon 462 (e.g., by looking at a respective icon and tapping two fingers, as illustrated in FIG. 4T), a data card 464 appears with information on Moscow's population, as illustrated in FIG. 4U. The spatial computing device 500 also outputs contextual sounds. Each icon 462 is unique and has a link to its source. For example, FIG. 4V illustrates another data card 466 being displayed in response to user selection of a different icon 462.

In some embodiments, the user can exit an immersive experience by selecting the “exit immersive space” icon 468 to return to the previous view that includes the dashboard 418 and the 3D terrain model 404. There, the user can select another icon for an immersive experience, to transition into a different immersive experience.

FIG. 4W shows the transition to immersive space with a different immersive scene 470 of Borisov. FIG. 4W shows that similar to the immersive scene 460, the user can select a respective icon (e.g., icon 462) to display a data card 472, hear contextual sounds. FIG. 4X shows that the user can select a respective icon 462 to display a respective unique data card, or select the “exit immersive space” icon 468 to exit the immersive scene 470.

In summary, the Minard application provides two complementary perspectives: a dashboard 418 and a 3D terrain model 404, each mapping to specific modules within the toolkit architecture. The dashboard 418 presents an aggregated overview of the data comprising troop size, temperature, and historical milestones. The 3D terrain model 404 provides a detailed, spatially grounded view of the historical narrative. The data asset management module 210 supplies structured data bindings to the visual elements, while the spatial scene construction module 220 and the rendering engine 230 instantiate troop movement paths, terrain features, and data overlays. Narrative sequencing and contextual annotations within the terrain are orchestrated through the storytelling asset generation module 240, providing users with location-specific insights as they progress through the narrative experience. To accommodate both structured storytelling and open-ended exploration, the toolkit 200 is leveraged to support an auto-narrative playback mode that leverages the toolkit's support for scene sequencing and branching logic to guide users through a chronological journey of Napoleon's march, and an exploration mode that enables users to freely navigate the 3D terrain visualization, using gesture and voice controls to interact with various narrative elements. Users can then transition into localized, fully immersive scenes from the terrain model and interact with 3D spatial markers at key historical sites, such as St. Basil's Cathedral in Moscow. These experiences are enriched by synchronized sound effects, contextual narration, and environmental effects, dynamically generated by the storytelling asset generation module 240 and the rendering engine 230.

In some embodiments, data will need to be structured in a way that supports both chronological storytelling and interactive exploration. Using the Minard application as an example, the original dataset includes troop movements across city locations over time, temperature over time, and troop strength over time. The city locations are geographically tied to coordinates. The dataset is transformed into a time series format (e.g., time series data). In some embodiments, the time series data is joined with the 3D model. In the Minard example, data of troop movements over time are mapped to the 3D terrain model. In some embodiments, data in the dataset is used to generate data visualizations and/or data dashboards, which are displayed and synchronized with the 3D representation in the immersive data story. In some embodiments, the data dashboards are generated on-the-fly. The storytelling asset generation module 240 can segment the dataset into meaningful narrative stages such as key historical events. Each of the events is associated with corresponding metadata. In some embodiments, the storytelling asset generation module 240 allows users to explore different aspects of the data in their own way rather than in a pure chronological way. In some embodiments, for a respective event, the corresponding data and metadata are linked and used as input to data cards, annotations, and spatial data markers for a respective event. The spatial data markers can be mapped to respective spatial entities and/or location or event data as part of the scene.

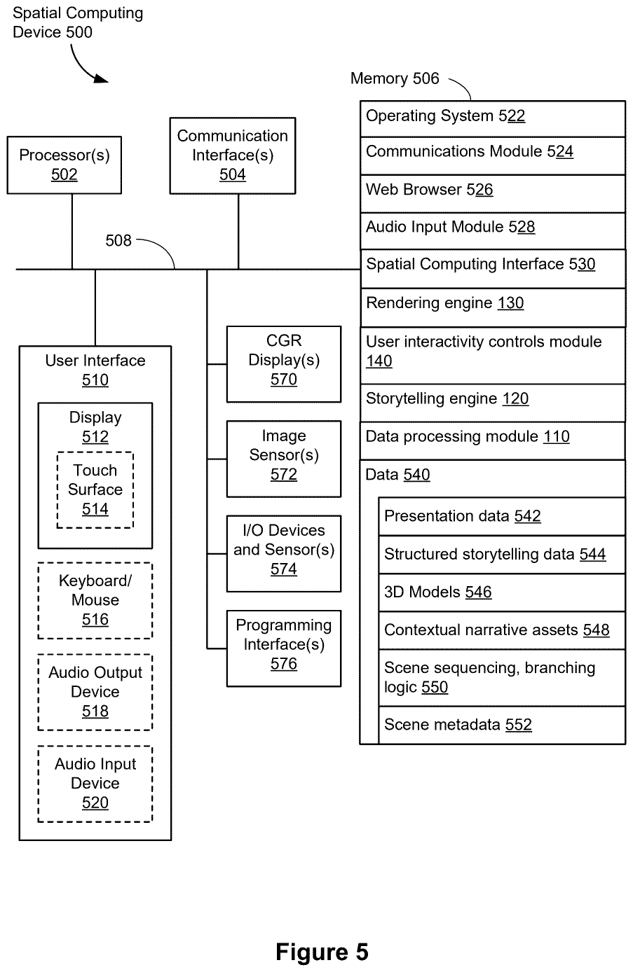

FIG. 5 is a block diagram of a spatial computing device 500, in accordance with some embodiments. Various examples of the spatial computing device 500 include a virtual reality (VR) device, an augmented reality (AR) device, or a spatial computing device that blends digital content with the physical world. In some embodiments, the spatial computing device 500 comprises a head mounted device (HMD).

The spatial computing device 500 typically includes one or more processing units 502 (e.g., processors or cores, microprocessors, application-specific integrated-circuits (ASICs), field-programmable gate arrays (FPGAs), graphics processing units (GPUs), central processing units (CPUs), processing cores, and/or the like)

The spatial computing device 500 includes one or more network or other communication interfaces 504 (e.g., universal serial bus (USB), FIREWIRE, THUNDERBOLT, IEEE 802.3x, IEEE 802.11x, IEEE 802.16x, global system for mobile communications (GSM), code division multiple access (CDMA), time division multiple access (TDMA), global positioning system (GPS), infrared (IR), BLUETOOTH, ZIGBEE, and/or the like type interface), one or more programming (e.g., I/O) interfaces 576, memory 506, and one or more communication buses 508 for interconnecting these components. In some embodiments, the communication buses 508 include circuitry (sometimes called a chipset) that interconnects and controls communications between system components.

The spatial computing device 500 includes a user interface 510. The user interface 510 typically includes a display device 512. In some embodiments, the spatial computing device 500 includes input devices such as a keyboard/mouse 216, and/or other input buttons. Alternatively or in addition, in some embodiments, the display device 512 includes a touch-sensitive surface 514, in which case the display device 512 is a touch-sensitive display. In some embodiments, the touch-sensitive surface 514 is configured to detect various swipe gestures (e.g., continuous gestures in vertical and/or horizontal directions) and/or other gestures (e.g., single/double tap). In computing devices that have a touch-sensitive display 514, a physical keyboard is optional (e.g., a soft keyboard may be displayed when keyboard entry is needed). The user interface 510 also includes an audio output device 518, such as speakers or an audio output connection connected to speakers, earphones, or headphones. Furthermore, some spatial computing devices 500 use a microphone and voice recognition to supplement or replace the keyboard. In some embodiments, the spatial computing device 500 includes an audio input device 520 (e.g., a microphone) to capture audio (e.g., speech from a user).

In some embodiments, the spatial computing device 500 includes one or more computer-generated reality (CGR) displays 570 that are configured to provide the CGR experience to the user and optionally status information related to the CGR experience. In some embodiments, the one or more CGR displays 570 correspond to holographic, digital light processing (DLP), liquid-crystal display (LCD), liquid-crystal on silicon (LCoS), organic light-emitting field-effect transitory (OLET), organic light-emitting diode (OLED), surface-conduction electron-emitter display (SED), field-emission display (FED), quantum-dot light-emitting diode (QD-LED), micro-electro-mechanical system (MEMS), and/or the like display types. In some embodiments, the one or more CGR displays 570 are capable of presenting mixed reality (MR) and/or virtual reality (VR) content.

In some embodiments, the spatial computing device 500 includes one or more image sensors 572 that are configured to obtain image data that corresponds to at least a portion of the face of the user that includes the eyes of the user (and may be referred to as an eye-tracking camera). In some embodiments, the one or more image sensors 572 are configured to obtain image data that corresponds to at least a portion of the user's hand(s) and optionally arm(s) of the user (and may be referred to as a hand-tracking camera).

In some embodiments, the spatial computing device 500 includes one or more I/O devices and sensors 574. The one or more I/O devices and sensors 574 can include at least one of an inertial measurement unit (IMU), an accelerometer, a gyroscope, a thermometer, one or more physiological sensors (e.g., blood pressure monitor, heart rate monitor, blood oxygen sensor, blood glucose sensor, etc.), one or more microphones, one or more speakers, a haptics engine, one or more depth sensors (e.g., a structured light, a time-of-flight, or the like), and/or the like.

In some embodiments, the memory 506 includes high-speed random-access memory, such as DRAM, SRAM, DDR RAM, or other random-access solid-state memory devices. In some embodiments, the memory 506 includes non-volatile memory, such as one or more magnetic disk storage devices, optical disk storage devices, flash memory devices, or other non-volatile solid-state storage devices. In some embodiments, the memory 506 includes one or more storage devices remotely located from the processors 502. The memory 506, or alternatively the non-volatile memory devices within the memory 506, includes a non-transitory computer-readable storage medium. In some embodiments, the memory 506, or the computer-readable storage medium of the memory 506, stores the following programs, modules, and data structures, or a subset or superset thereof:
an operating system 522, which includes procedures for handling various basic system services and for performing hardware dependent tasks;
a communications module 524, which is used for connecting the spatial computing device 500 to other computers (e.g., computer system 600) and devices via the one or more communication interfaces 504 (wired or wireless), such as the Internet, other wide area networks, local area networks, metropolitan area networks, and so on;
a web browser 526 (or other application capable of displaying web pages), which enables a user to communicate over a network with remote computers or devices;
an audio input module 528 (e.g., a microphone module), which processes audio captured by the audio input device 520. The captured audio may be sent to a remote server (e.g., computer system 600) and/or processed by an application executing on the spatial computing device 500;
a spatial computing interface 530, for presenting computer-generated reality content to a user through one or more displays and associated audio components and to enable user interaction with an immersive data story within a spatial computing environment. In some embodiments, the spatial computing interface 530 supports presentation of a macro-level overview and one or more location-specific immersive scenes, and further supports receipt of user interaction including gesture inputs, gaze inputs, and voice commands through the spatial computing device. In some embodiments, the spatial computing interface 530 further presents multisensory feedback including spatial audio, haptic feedback, or other feedback during playback of the immersive data story. In some embodiments, spatial computing interface 530 is the interface component of spatial computing device 500;
a rendering engine 130, for rendering a macro-level overview including a data dashboard and one or more location-specific immersive scenes corresponding to spatial locations represented in an immersive data story;
a user interactivity controls module 140, for receiving gesture inputs, gaze inputs, and voice commands. In some embodiments, the user interactivity controls module 140 can use the received inputs to select spatial markers, trigger transitions between the macro-level overview and the one or more location-specific immersive scenes, navigate to named locations, and request detail-on-demand content including data cards, annotations, or transcripts;
a storytelling engine 120, for controlling scene sequencing, narration, and branching logic during playback of the immersive data story. In some embodiments, the storytelling engine 120 can adapt narrative progression based on user interaction; and
a data processing module 110, for accessing structured storytelling data associated with events, temporal information, spatial information, and metadata. In some embodiments, the data processing module 110 can provide data bindings between the structured storytelling data and visual elements rendered within the spatial computing device.

In some embodiments, the spatial computing device 500 locally performs immersive presentation and user interaction functions, including output of audio narration, synchronization of environmental audio, and rendering optimization using decimation, texture baking, or both.

In some embodiments, the spatial computing device 500 stores data 540, including presentation data 542 for an overview presentation of an immersive data story and interaction-linked presentation data associating respective scene objects with context-specific narrative content and corresponding localized immersive presentations. In some embodiments, the spatial computing device 500 further stores structured storytelling data 544, including event data, temporal data, spatial data, and metadata associated with locations, objects, or narrative stages of the immersive data story, as well as one or more three-dimensional models 546 and corresponding visual assets used to render a macro-level overview and one or more location-specific immersive scenes. In some embodiments, the spatial computing device 500 stores contextual narrative assets 548, including data cards, spatial markers, audio narratives, annotations, and transcripts, together with scene sequencing data, narration and branching logic 550, named-location data, and interaction-linked data that maps user inputs to scene transitions, contextual content retrieval, or localized immersive playback. In some embodiments, the spatial computing device 500 further stores scene metadata 552, identifiers, spatial metadata, temporal sequencing information, interaction handlers, rendered assets, and optimized model data generated using decimation, texture baking, or both, thereby enabling responsive immersive playback and user interaction within the spatial computing environment.

In various implementations, the models and/or modules described herein may be classification, predictive, generative, conversational, or another form of artificial intelligence (AI) technology, such as AI model(s), agents, etc., implementing one or more forms of machine learning, a neural network, statistical modeling, deep learning, automation, natural language processing, or other similar technology. The AI technology may be included as part of a network or system comprising a hardware-or software-based framework for training, processing, fine-tuning, or performing any other implementation steps. Furthermore, the AI technology may include a hardware-or software-based framework that performs one or more functions, such as retrieving, generating, accessing, transmitting, etc.

Moreover, the AI technology may be trained or fine-tuned using supervised, unsupervised, or other AI training techniques. In various implementations, the AI technology may be trained or fine-tuned using a set of general datasets or a set of datasets directed to a particular field or task. Additionally or alternatively, the AI technology may be intermittently updated at a set of interval or in real time based on resulting output or additional data to further train the AI technology. The AI technology may offer a variety of capabilities including text, audio, image, or content generation, translation, summarization, classification, prediction, recommendation, time-series forecasting, searching, matching, pairing, and more. These capabilities may be provided in the form of output produced by the AI technology in response to a particular prompt or other input. Furthermore, the AI technology may implement Retrieval-Augmented Generation (RAG) or other techniques after training or fine-tuning by accessing a set of documents or knowledge base directed to a particular field or website other than the training or fine-tuning data to influence the AI technology's output with the set of documents or knowledge base.

To further guide and train output of the AI technology, a plurality of input prompts may be provided to the AI technology for the purpose of eliciting particular responses. In various implementations, the plurality of input prompts may correspond to the particular field or task to which the AI technology is trained. Additionally, the AI technology may be implemented along with a plurality of additional AI technologies. For example, a first AI model may produce a first output, which is used as input for a second AI model to produce a second output. These AI technologies may be used in succession of one another, in parallel with another, or a combination of both. Furthermore, the AI technologies may be merged in a variety of implementations, for example, by bagging, boosting, stacking, etc. the AI technologies.

Each of the above identified executable modules, applications, or sets of procedures may be stored in one or more of the previously mentioned memory devices, and corresponds to a set of instructions for performing a function described above. The above identified modules or programs (i.e., sets of instructions) need not be implemented as separate software programs, procedures, or modules, and thus various subsets of these modules may be combined or otherwise re-arranged in various embodiments. In some embodiments, the memory 506 stores a subset of the modules and data structures identified above. Furthermore, the memory 506 may store additional modules or data structures not described above. In some embodiments, a subset of the programs, modules, and/or data stored in the memory 506 is stored on and/or executed by a computer system 600.

Although FIG. 5 shows a spatial computing device 500, FIG. 5 is intended more as a functional description of the various features that may be present rather than as a structural schematic of the embodiments described herein. In practice, and as recognized by those of ordinary skill in the art, items shown separately could be combined and some items could be separated. In addition, some of the programs, functions, procedures, or data shown above with respect to the spatial computing device 500 may be stored or executed on a computer system 600.

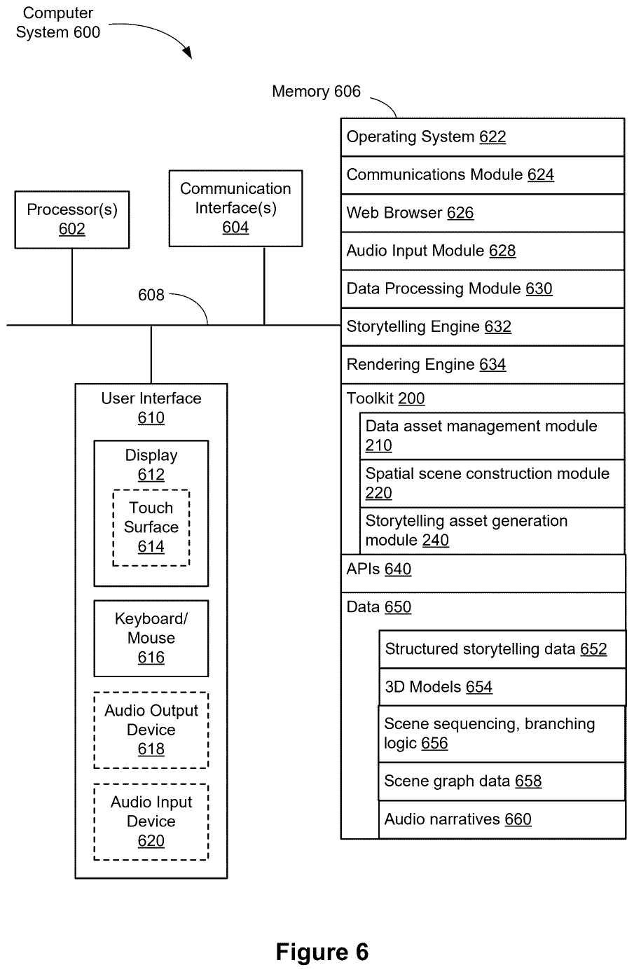

FIG. 6 is a block diagram of a computer system 600, in accordance with some embodiments. Various examples of the computing device 600 include a desktop computer, a laptop computer, a tablet computer, and other computing devices that have a display and a processor capable of running a toolkit 200. The computer system 600 typically includes one or more processors 602 (processing units or cores, central processing unit (CPU) and/or graphics processing unit (GPU), one or more network or other communication interfaces 604, memory 606, and one or more communication buses 608 for interconnecting these components. In some embodiments, the communication buses 608 include circuitry (sometimes called a chipset) that interconnects and controls communications between system components.

The computer system 600 includes a user interface 610. The user interface 610 typically includes a display device 612. In some embodiments, computer system 600 includes input devices such as a keyboard, mouse, and/or other input buttons 616. Alternatively or in addition, in some embodiments, the display device 612 includes a touch-sensitive surface 614, in which case the display device 612 is a touch-sensitive display. In some embodiments, the touch-sensitive surface 614 is configured to detect various swipe gestures (e.g., continuous gestures in vertical and/or horizontal directions) and/or other gestures (e.g., single/double tap). In computer systems that have a touch-sensitive display 614, a physical keyboard is optional (e.g., a soft keyboard may be displayed when keyboard entry is needed). The user interface 610 also includes an audio output device 618, such as speakers or an audio output connection connected to speakers, earphones, or headphones. Furthermore, some computer systems 600 use a microphone and voice recognition to supplement or replace the keyboard. In some embodiments, the computer system 600 includes an audio input device 620 (e.g., a microphone) to capture audio (e.g., speech from a user).

In some embodiments, the memory 606 includes high-speed random-access memory, such as DRAM, SRAM, DDR RAM, or other random-access solid-state memory devices. In some embodiments, the memory 606 includes non-volatile memory, such as one or more magnetic disk storage devices, optical disk storage devices, flash memory devices, or other non-volatile solid-state storage devices. In some embodiments, the memory 606 includes one or more storage devices remotely located from the processors 602. The memory 606, or alternatively the non-volatile memory devices within the memory 606, includes a non-transitory computer-readable storage medium. In some embodiments, the memory 606, or the computer-readable storage medium of the memory 606, stores the following programs, modules, and data structures, or a subset or superset thereof:
an operating system 622, which includes procedures for handling various basic system services and for performing hardware dependent tasks;
a communications module 624, which is used for connecting the computer system 600 to other computers (e.g., spatial computing device 500) and devices via the one or more communication interfaces 604 (wired or wireless), such as the Internet, other wide area networks, local area networks, metropolitan area networks, and so on;
a web browser 626 (or other application capable of displaying web pages), which enables a user to communicate over a network with remote computers or devices;
an audio input module 628 (e.g., a microphone module), which processes audio captured by the audio input device 620. The captured audio may be sent to a remote server and/or processed by an application executing on the computer system 600;
data processing module 630, for ingesting structured storytelling data from one or more datasets, databases, application programming interfaces, or other data sources. In some embodiments, data processing module 630 can organize the structured storytelling data for narrative playback and interactive exploration
a storytelling engine 632 (e.g., storytelling engine 120), for generating scene sequencing, narration, and branching logic for an immersive data story. In some embodiments, storytelling engine 632 can define transitions between overview content and location-specific immersive scenes
a rendering engine 634 (e.g., rendering engine 130 or 230), for generating visual output for dashboards, three-dimensional models, spatial markers, and immersive scenes for presentation on the spatial computing device 500; and
a toolkit 200, including:
   a data asset management module 210, for binding structured storytelling data to visual assets and storing associated metadata for runtime retrieval.
   a spatial scene construction module 220, for generating scene objects, spatial metadata, temporal sequencing, interaction handlers, and scene graph data defining relationships among locations, events, and narrative states;
   a storytelling asset generation module 240, for generating data cards, spatial markers, text narratives, audio narratives, and other contextual assets based on the structured storytelling data and the scene graph data

In some embodiments, the computer system 600 includes one or more application programming interfaces (APIs) 640 configured to support generation, management, and presentation of an immersive data story. In some embodiments, the APIs 640 include a data ingestion API configured to receive structured storytelling data from one or more external datasets, databases, or network-accessible sources. In some embodiments, the APIs 640 include a narrative control API configured to provide scene sequencing data, narration data, branching logic, or transition definitions to one or more software modules of the computer system 600. In some embodiments, the APIs 640 include a scene management API configured to provide scene graph data, spatial metadata, object identifiers, or location-specific immersive scene definitions. In some embodiments, the APIs 640 include an interaction API configured to receive, interpret, or route gesture inputs, gaze inputs, voice commands, or other user interaction events. In some embodiments, the APIs 640 include an asset retrieval API configured to access one or more three-dimensional models, textures, audio assets, data cards, annotations, or transcripts. In some embodiments, the APIs 640 include a presentation synchronization API configured to coordinate overview content, localized immersive presentations, contextual narrative content, and transition events between the computer system 600 and a spatial computing device 500. In some embodiments, the APIs 640 include a text-to-speech API for converting textual narratives corresponding to the structured event data into audio narratives using a text-to-speech model. In some embodiments, one or more of the APIs 640 are internal APIs between software modules of the computer system 600, and in some embodiments, one or more of the APIs 640 are external APIs configured for communication with remote services or third-party data sources.

In some embodiments, the computer system 600 includes data 650 that can be stored locally on the computer system 600 or in a database. In some embodiments, the data 650 includes structured storytelling data 652 associated with an immersive data story, including event data, temporal data, spatial data, metadata, and narrative-stage data for use in generating overview presentations and localized immersive presentations. In some embodiments, the computer system further stores one or more three-dimensional models 654, visual assets, storytelling assets, and scene data for rendering dashboards, spatial markers, data cards, and location-specific immersive scenes for presentation on a spatial computing device. In some embodiments, the computer system also stores scene sequencing data 656, narration data, branching logic, named-location data, interaction-handler data, and transition data defining relationships among overview content, scene objects, contextual narrative content, and localized immersive playback. In some embodiments, the computer system further stores scene graph data 658, identifiers, spatial metadata, temporal sequencing information, runtime retrieval data, rendered assets, and optimized model data generated using decimation, texture baking, or both. In some embodiments, the computer system also stores audio narratives 660, environmental audio data, annotations, transcripts, and other contextual assets used to support adaptive storytelling, toolkit-based authoring, pre-render processing, and transmission of presentation data and interaction-linked presentation data to the spatial computing device 500.

In some embodiments, the computer system 600 performs authoring, data management, narrative generation, and pre-render processing functions, while the spatial computing device performs 500 immersive playback and user interaction functions, although one or more of the foregoing modules can be distributed across the spatial computing device 500 and the computer system 600 in different implementations.

Each of the above identified executable modules, applications, or sets of procedures may be stored in one or more of the previously mentioned memory devices, and corresponds to a set of instructions for performing a function described above. The above identified modules or programs (i.e., sets of instructions) need not be implemented as separate software programs, procedures, or modules, and thus various subsets of these modules may be combined or otherwise re-arranged in various embodiments. In some embodiments, the memory 606 stores a subset of the modules and data structures identified above. Furthermore, the memory 606 may store additional modules or data structures not described above. In some embodiments, a subset of the programs, modules, and/or data stored in the memory 606 is stored on and/or executed by spatial computing device 500.

Although FIG. 6 shows a computer system 600, FIG. 6 is intended more as a functional description of the various features that may be present rather than as a structural schematic of the embodiments described herein. In practice, and as recognized by those of ordinary skill in the art, items shown separately could be combined and some items could be separated. In addition, some of the programs, functions, procedures, or data shown above with respect to the computer system 600 may be stored or executed on a spatial computing device 500.

In various implementations, the models and/or modules described herein may be classification, predictive, generative, conversational, or another form of artificial intelligence (AI) technology, such as AI model(s), agents, etc., implementing one or more forms of machine learning, a neural network, statistical modeling, deep learning, automation, natural language processing, or other similar technology. The AI technology may be included as part of a network or system comprising a hardware-or software-based framework for training, processing, fine-tuning, or performing any other implementation steps. Furthermore, the AI technology may include a hardware- or software-based framework that performs one or more functions, such as retrieving, generating, accessing, transmitting, etc.

Moreover, the AI technology may be trained or fine-tuned using supervised, unsupervised, or other AI training techniques. In various implementations, the AI technology may be trained or fine-tuned using a set of general datasets or a set of datasets directed to a particular field or task. Additionally or alternatively, the AI technology may be intermittently updated at a set of interval or in real time based on resulting output or additional data to further train the AI technology. The AI technology may offer a variety of capabilities including text, audio, image, or content generation, translation, summarization, classification, prediction, recommendation, time-series forecasting, searching, matching, pairing, and more. These capabilities may be provided in the form of output produced by the AI technology in response to a particular prompt or other input. Furthermore, the AI technology may implement Retrieval-Augmented Generation (RAG) or other techniques after training or fine-tuning by accessing a set of documents or knowledge base directed to a particular field or website other than the training or fine-tuning data to influence the AI technology's output with the set of documents or knowledge base.

To further guide and train output of the AI technology, a plurality of input prompts may be provided to the AI technology for the purpose of eliciting particular responses. In various implementations, the plurality of input prompts may correspond to the particular field or task to which the AI technology is trained. Additionally, the AI technology may be implemented along with a plurality of additional AI technologies. For example, a first AI model may produce a first output, which is used as input for a second AI model to produce a second output. These AI technologies may be used in succession of one another, in parallel with another, or a combination of both. Furthermore, the AI technologies may be merged in a variety of implementations, for example, by bagging, boosting, stacking, etc. the AI technologies.

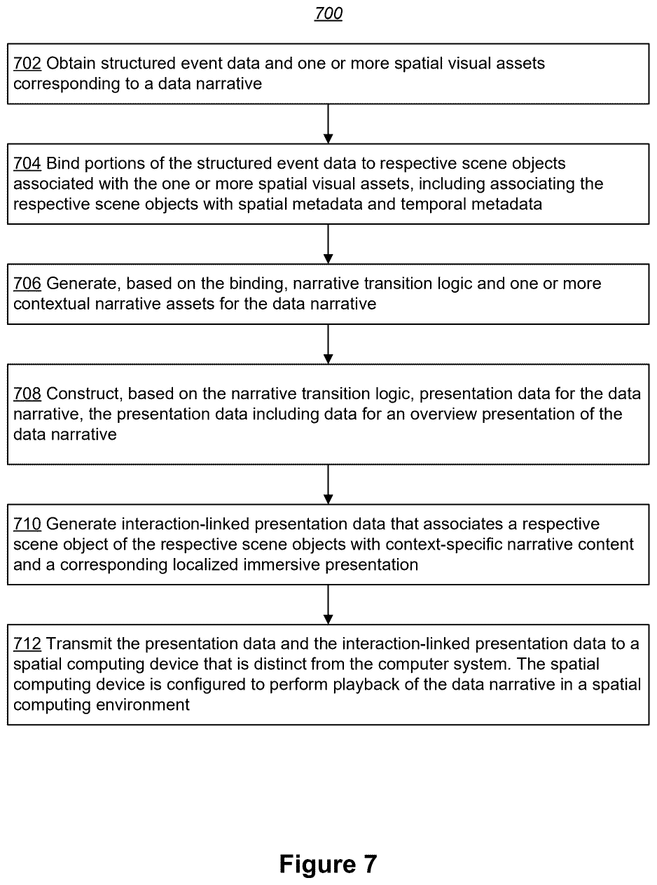

FIG. 7 provides a flowchart of an example process for generating immersive data narratives, in accordance with some embodiments.

The method 700 is performed at a computer system (e.g., spatial computing device 500 or computer system 600) that includes one or more processors (e.g., processor(s) 502 or processor(s) 602, and memory (e.g., memory 506 or memory 606). The memory stores one or more programs configured for execution by the one or more processors. In some embodiments, the operations shown in FIGS. 1, 2, 3, and 4A to 4X correspond to instructions stored in the memory or other non-transitory computer-readable storage medium. The computer-readable storage medium may include a magnetic or optical disk storage device, solid state storage devices such as Flash memory, or other non-volatile memory device or devices. In some embodiments, the instructions stored on the computer-readable storage medium include one or more of: source code, assembly language code, object code, or other instruction format that is interpreted by one or more processors. Some operations in the method 700 may be combined with the method 800, and/or the order of some operations may be changed.

In step 702, the computer system obtains structured event data (e.g., data files 252 and structured storytelling data 544/652) and one or more spatial visual assets corresponding to a data narrative. Obtaining structured event data together with corresponding spatial visual assets for a data narrative allows the computer system to assemble a common input set from which the narrative can be built in a spatial computing environment. Because the event data carries narrative structure and the spatial visual assets provide a visual context for that structure, the computer system can align subsequent presentation behavior with the underlying data rather than treating the visual scene and the narrative content as separate layers. This arrangement enables the narrative to be rendered as a data-driven spatial experience and supports guided and exploratory presentation of complex information.

In some embodiments, the structured event data comprises time-series data including location data, time data, and event metadata for events of the data narrative. In some embodiments, the one or more spatial visual assets comprise a three-dimensional terrain model, one or more building models, or one or more historical reconstruction models (e.g., three-dimensional models 254, 3D models 546/654, 3D terrain model 404).

In step 704, the computer system binds portions of the structured event data to respective scene objects associated with the one or more spatial visual assets, including associating the respective scene objects with spatial metadata and temporal metadata. For example, as explained in FIG. 2, the data binding component 212 of the data asset management module 210 establishes bindings between structured data fields and corresponding visual assets or scene objects. That same paragraph explains that object registration component 214 registers objects and associates them with identifiers, spatial metadata, temporal sequencing information, and interaction handlers. Binding portions of the structured event data to respective scene objects, including associating the scene objects with spatial metadata and temporal metadata, allows the computer system to maintain a persistent relationship between the underlying data and the rendered spatial content. This association enables scene objects to be positioned, sequenced, and retrieved according to where an event occurs and when the event occurs, so that user interactions with the scene can be resolved against the correct narrative context. By organizing the presentation around data-bound scene objects instead of unconnected graphical elements, the computer system supports coordinated updates, interaction handling, and spatially and temporally coherent scene construction.

In some embodiments, binding portions of the structured event data to the respective scene objects includes establishing persistent linkages between data fields of the structured event data and the respective scene objects. For example, in some embodiments, the data binding component 212 establishes bindings between data fields of the structured data and corresponding visual assets or scene objects, thereby enabling persistent linkages between underlying data and rendered content.

In some embodiments, binding portions of the structured event data to the respective scene objects further includes augmenting the respective scene objects with distinct identifiers, position metadata, orientation metadata, and interaction affordances.

In step 706, the computer system generates, based on the binding, narrative transition logic and one or more contextual narrative assets for the data narrative. Generating narrative transition logic and contextual narrative assets based on the binding allows the computer system to control progression of the data narrative through defined scene states and transition conditions while also preparing narrative content that is specific to a selected object or location. This step enables interaction-responsive storytelling in which a user action can trigger the appropriate contextual overlay, narration, marker behavior, or scene change from the same bound data structure. As a result, the narrative can branch or advance in a controlled manner while still remaining tied to the spatial and temporal organization of the underlying events.

In some embodiments, generating the one or more contextual narrative assets includes generating one or more data cards (e.g., using data card generation component 242), one or more audio narratives (e.g., using audio narrative generation component 244, and illustrated by audio narratives accompanying the screenshots in FIGS. 4A to 4X), and one or more spatial markers (e.g., using spatial marker generation component 246) for the data narrative.

In some embodiments, generating the one or more audio narratives includes converting textual narratives corresponding to the structured event data into audio narratives using a text-to-speech model. For example, in some embodiments, the toolkit 200 converts textual narratives from the data files into audio narratives using a text-to-speech API (e.g., APIs 640).

In some embodiments, generating the narrative transition logic includes defining a state machine that encodes scene states, transition conditions, and animation sequences for the data narrative. For example, as described with reference to FIG. 2, the toolkit 200 can manage transitions between narrative stages through a state machine that encodes scene states, transition conditions, and animation sequences. The narrative transition logic is also shown in operation in FIGS. 4A to 4X: the user can begin in an overview, enter a guided walkthrough, switch to self-exploration, select spatial markers to reveal data cards, use controls to move through the story, issue voice commands to navigate to named locations, and enter deeper immersive scenes at selected locations.

In some embodiments, the narrative transition logic is configured to support a guided walkthrough mode and an exploration mode for the data narrative, as described with reference to FIGS. 4A to 4X.

In step 708, the computer system constructs, based on the narrative transition logic, presentation data for the data narrative, the presentation data including data for an overview presentation of the data narrative. For example, as explained in FIG. 2, the rendering engine 230 receives data assets and storytelling assets and generates rendered assets 256 for use in constructing a macro-level overview and one or more location-specific immersive scenes. Constructing presentation data based on the narrative transition logic, including data for an overview presentation, allows the computer system to provide a coordinated macro-level view of the data narrative together with the immersive scene content. Because the overview presentation is derived from the same transition framework that governs the spatial narrative, charts, dashboards, and other aggregate views can remain synchronized with the corresponding three-dimensional presentation. This arrangement helps preserve user orientation as the presentation moves between broader narrative context and more focused spatial scenes, and supports comprehension of multidimensional data by linking overview information to the evolving immersive experience.

In some embodiments, constructing the presentation data includes generating the overview presentation to update in real time in response to user interaction with a three-dimensional representation of the data narrative

In some embodiments, the overview presentation comprises one or more data charts (e.g., charts 422A and 422B) or dashboards (e.g., dashboard 418) synchronized with a three-dimensional representation of the data narrative (e.g., 3D terrain model 404).

In step 710, the computer system generates interaction-linked presentation data that associates a respective scene object of the respective scene objects with context-specific narrative content and a corresponding localized immersive presentation. Generating interaction-linked presentation data that associates a respective scene object with context-specific narrative content and a corresponding localized immersive presentation allows the computer system to present detail-on-demand in response to interaction with that scene object. This association enables a gaze input, gesture input, or voice command directed to the scene object to call up the narrative content that is relevant to that object and, where appropriate, to transition into a localized immersive scene corresponding to that context. In this way, the computer system can move from an overview presentation to a more focused immersive presentation without losing the connection between user input, narrative content, and the represented event.

In some embodiments, the interaction-linked presentation data is configured such that a gaze input, a gesture input, or a voice command directed to a respective scene object causes presentation of the context-specific narrative content associated with the respective scene object.

In some embodiments, the corresponding localized immersive presentation includes synchronized sound effects and one or more environmental effects corresponding to an event represented by the respective scene object.

In step 712, the computer system transmits the presentation data and the interaction-linked presentation data to a spatial computing device (e.g., spatial computing device 500) that is distinct from the computer system. The spatial computing device is configured to perform playback of the data narrative in a spatial computing environment (e.g., spatial computing environment 400 as shown in FIGS. 4A-4X). Transmitting the presentation data and the interaction-linked presentation data to a playback computing device that is separate from the computer system allows narrative generation and immersive playback to be divided between different devices. The feature allows one system to perform authoring, data preparation, and generation of the narrative presentation structures, while the separate playback device performs playback and user interaction in the spatial computing environment using the received data. This arrangement supports responsive immersive presentation at the playback device while preserving the data-driven associations needed for context retrieval, scene transitions, and localized immersive playback.

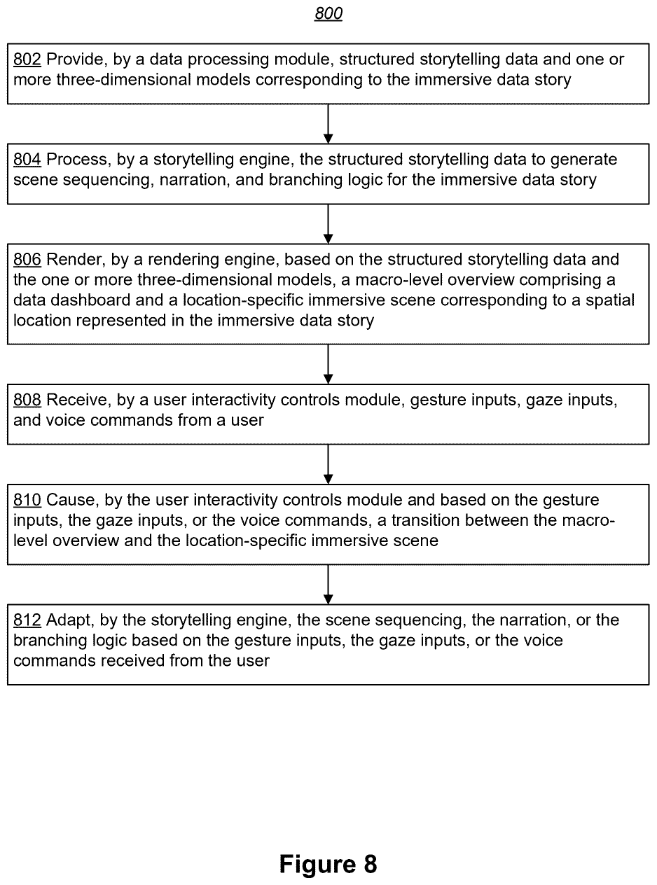

FIG. 8 provides a flowchart of an example process for generating immersive data narratives in a spatial computing environment, in accordance with some embodiments.

The method 800 is performed at a computer system (e.g., spatial computing device 500 or computer system 600) that includes one or more processors (e.g., processor(s) 502 or processor(s) 602, and memory (e.g., memory 506 or memory 606). The memory stores one or more programs configured for execution by the one or more processors. In some embodiments, the operations shown in FIGS. 1, 2, 3, and 4A to 4X correspond to instructions stored in the memory or other non-transitory computer-readable storage medium. The computer-readable storage medium may include a magnetic or optical disk storage device, solid state storage devices such as Flash memory, or other non-volatile memory device or devices. In some embodiments, the instructions stored on the computer-readable storage medium include one or more of: source code, assembly language code, object code, or other instruction format that is interpreted by one or more processors. Some operations in the method 800 may be combined with the method 700, and/or the order of some operations may be changed.

In step 802, the computer system (e.g., via data processing module 110) provides structured storytelling data and one or more three-dimensional models corresponding to the immersive data story. For example, FIG. 1 describes the data processing module 110 provides structured storytelling data 112 and one or more three-dimensional models 114 corresponding to an immersive data story. Providing structured storytelling data together with one or more three-dimensional models allows the immersive data story to be constructed as a coordinated, data-driven spatial narrative. By supplying narrative-driving data in a structured form and supplying corresponding three-dimensional assets for the represented environment, the computer system can bind data fields to scene objects, align narrative content with spatial context, and support subsequent rendering and narrative control operations from a common data foundation. This arrangement can also support real-time updating of data-driven visual elements and can preserve geographic context while immersive content is presented.

In step 804, the computer system processes the structured storytelling data to generate scene sequencing, narration, and branching logic for the immersive data story. For example, the storytelling engine 120 processes the structured storytelling data to generate scene sequencing 122 and narration and branching logic 124. Processing the structured storytelling data to generate scene sequencing, narration, and branching logic allows the immersive data story to progress through coherent narrative stages while remaining responsive to authored control logic. This processing enables the computer system to derive an ordered presentation flow, contextual narration, and transition conditions from the underlying storytelling data, so that the experience need not be limited to a fixed visual playback sequence. As a result, the computer system can support both guided walkthroughs and user-directed exploration while keeping scene changes and narrative content tied to the underlying spatial and temporal organization of the story.

In step 806, the computer system renders, based on the structured storytelling data and the one or more three-dimensional models, a macro-level overview comprising a data dashboard (e.g., dashboard 418) and a location-specific immersive scene corresponding to a spatial location represented in the immersive data story. For example, the rendering engine 130 renders visual content for the immersive data story based on the structured storytelling data 112 and the 3D models 114. Rendering a macro-level overview that includes a data dashboard together with a location-specific immersive scene corresponding to a represented spatial location allows a user to access high-level information and localized contextual detail within the same storytelling framework. By synchronizing dashboard content with three-dimensional scene content (e.g., as illustrated in the transition from FIG. 4H, to FIG. 4I, to FIG. 4J, and FIG. 4K), the computer system can maintain overview context while also presenting location-specific immersion, which can improve comprehension of complex spatial and temporal relationships and help preserve user orientation during exploration. This coordinated rendering can also reduce the need to mentally reconcile separate views that would otherwise be presented in isolation.

In step 808, the computer system receives gesture inputs, gaze inputs, and voice commands from a user. For example, user interactivity controls module 140 includes gesture-based controls 142 and multisensory feedback 144, and is configured to receive gaze inputs and voice commands and provide corresponding user interaction 126 to the storytelling engine 120 and the rendering engine 130. Receiving gesture inputs, gaze inputs, and voice commands allows the immersive data story to be controlled through multiple interaction modalities within the spatial computing environment. This input arrangement enables selection of scene objects, retrieval of context-specific content, manipulation of three-dimensional content, and navigation commands without requiring a single rigid interaction technique. As a result, the computer system can support detail-on-demand interactions and can provide a more direct control path for invoking story functions associated with displayed spatial elements.

In step 810, the computer system causes, based on the gesture inputs, the gaze inputs, or the voice commands, a transition between the macro-level overview and the location-specific immersive scene. For example, the user interactivity controls module 140 can detect a gaze directed to a selected spatial marker and, responsive to selecting that marker, cause a transition between the macro-level overview and the corresponding location-specific immersive scene. Causing a transition between the macro-level overview and the location-specific immersive scene based on the gesture inputs, the gaze inputs, or the voice commands allows the user to move between overview-level context and localized immersive detail in response to interaction. This transition behavior enables on-demand drill-down from a dashboard or overview presentation into a spatially corresponding immersive scene, while still allowing the user to return to the broader narrative context. By coupling the transition to multimodal user input, the computer system can support guided walkthroughs and open exploration in a manner that helps maintain orientation across different levels of narrative presentation.

In step 812, the computer system adapts the scene sequencing, the narration, or the branching logic based on the gesture inputs, the gaze inputs, or the voice commands received from the user. For example, the narration and branching logic 124 can adapt based on user interactions. The storytelling engine 120 can adapt the scene sequencing 122 and the narration and branching logic 124 based on user interaction received through the user interactivity controls module. Adapting the scene sequencing, the narration, or the branching logic based on the gesture inputs, the gaze inputs, or the voice commands allows the immersive data story to change its progression in response to user interaction. This adaptation enables the storytelling engine to alter the next scene state, narrative output, or branch selection according to received interaction signals, so that story progression can reflect user choices rather than following only a predetermined linear path. As a result, the computer system can provide interaction-responsive narrative control while keeping the presented content coordinated with the structured storytelling data and the rendered spatial environment.

In some embodiments, the computer system presents a guided mode in which the scene sequencing and the narration are presented according to a predefined narrative progression. In some embodiments, the guided mode is activated in accordance with user selection of a “walkthrough option” 408.

In some embodiments, the computer system enables a free exploration mode in which a user selectively navigates among spatial locations represented in the immersive data story. In some embodiments, the free exploration mode is activated in accordance with user selection of the “Explore on my own” option in FIG. 4C.

In some embodiments, the computer system renders one or more spatial markers (e.g., spatial markers 428) anchored to corresponding spatial locations in the location-specific immersive scene.

In some embodiments, receiving the gaze inputs comprises detecting a gaze directed to a selected one of the one or more spatial markers. In some embodiments, responsive to selection of the selected one of the one or more spatial markers (e.g., spatial marker 428), the computer system causes the transition between the macro-level overview and the location-specific immersive scene corresponding to the selected one of the one or more spatial markers. In some embodiments, the computer system preserves geographic orientation during transitions from the macro-level overview to the location-specific immersive scene by maintaining stored spatial metadata linking a selected scene object in the overview to a corresponding immersive presentation space. In some embodiments, use of stored spatial metadata and transition logic allows the computer system to generate a spatially coherent transition path that preserves location correspondence between the overview and the immersive scene rather than initiating an unrelated scene change.

In some embodiments, the computer system renders one or more data cards (e.g., data cards 432, 438, 440, 464, 466, and 472) comprising contextual data associated with a selected spatial location.

In some embodiments, the computer system outputs audio narration corresponding to at least one scene of the immersive data story. In some embodiments, the computer system further synchronizes synchronizing environmental audio with the audio narration based on a scene of the immersive data story. This is described in the example of FIGS. 4A to 4X.

In some embodiments, the computer system optimizes rendering of the one or more three-dimensional models using decimation or texture baking (e.g., via rendering engine 130).

In some embodiments, the computer system receives (e.g., via microphone icon 452) a voice command specifying a named location represented in the immersive data story (e.g., Go to Dorogobuzh,” as described with reference to FIG. 4P), and causes navigation to the location-specific immersive scene corresponding to the named location.

It will be understood that, although the terms “first,” “second,” etc. may be used herein to describe various elements, these elements should not be limited by these terms. These terms are only used to distinguish one element from another. The terminology used herein is for the purpose of describing particular embodiments only and is not intended to be limiting of the claims. As used in the description of the embodiments and the appended claims, the singular forms “a,” “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “plurality” denotes two or more. For example, a plurality of components indicates two or more components. The term “determining” encompasses a wide variety of actions and, therefore, “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing and the like.

The phrase “based on” does not mean “based only on,” unless expressly specified otherwise. In other words, the phrase “based on” describes both “based only on” and “based at least on.”

As used herein, the term “exemplary” means “serving as an example, instance, or illustration,” and does not necessarily indicate any preference or superiority of the example over any other configurations or embodiments.

As used herein, the term “and/or” encompasses any combination of listed elements. For example, “A, B, and/or C” entails each of the following possibilities: A only, B only, C only, A and B without C, A and C without B, B and C without A, and a combination of A, B, and C.

The terminology used in the description of the invention herein is for the purpose of describing particular embodiments only and is not intended to be limiting of the invention. As used in the description of the invention and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

The foregoing description, for the purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

What is claimed is:

1. A non-transitory computer-readable medium storing one or more programs configured for execution by one or more processors of a computer system, the one or more programs comprising instructions for:
obtaining structured event data and one or more spatial visual assets corresponding to a first data narrative;
binding portions of the structured event data to respective scene objects associated with the one or more spatial visual assets, including associating the respective scene objects with spatial metadata and temporal metadata;
generating, based on the binding, narrative transition logic and one or more contextual narrative assets for the first data narrative;
constructing, based on the narrative transition logic, presentation data for the first data narrative, the presentation data including data for an overview presentation of the first data narrative;
generating interaction-linked presentation data that associates a respective scene object of the respective scene objects with context-specific narrative content and a corresponding localized immersive presentation; and
transmitting the presentation data and the interaction-linked presentation data to a playback computing device that is separate from the computer system, the playback computing device configured to perform playback of the first data narrative in a spatial computing environment.

2. The non-transitory computer-readable medium of claim 1, wherein the structured event data comprises time-series data including location data, time data, and event metadata for events of the first data narrative.

3. The non-transitory computer-readable medium of claim 1, wherein the one or more spatial visual assets comprise a three-dimensional terrain model, one or more building models, or one or more historical reconstruction models.

4. The non-transitory computer-readable medium of claim 1, wherein the instructions for binding portions of the structured event data to the respective scene objects include instructions for establishing persistent linkages between data fields of the structured event data and the respective scene objects.

5. The non-transitory computer-readable medium of claim 1, wherein the instructions for binding portions of the structured event data to the respective scene objects further include instructions for augmenting the respective scene objects with distinct identifiers, position metadata, orientation metadata, and interaction affordances.

6. The non-transitory computer-readable medium of claim 1, wherein the instructions for generating the one or more contextual narrative assets include instructions for generating one or more data cards, one or more audio narratives, and one or more spatial markers for the first data narrative.

7. The non-transitory computer-readable medium of claim 1, wherein the instructions for generating the narrative transition logic include instructions for defining a state machine that encodes scene states, transition conditions, and animation sequences for the first data narrative.

8. The non-transitory computer-readable medium of claim 1, wherein the overview presentation comprises one or more data charts or dashboards synchronized with a three-dimensional representation of the first data narrative.

9. The non-transitory computer-readable medium of claim 1, wherein the interaction-linked presentation data is configured such that a gaze input, a gesture input, or a voice command directed to a respective scene object causes presentation of the context-specific narrative content associated with the respective scene object.

10. The non-transitory computer-readable medium of claim 1, wherein the corresponding localized immersive presentation includes synchronized sound effects and one or more environmental effects corresponding to an event represented by the respective scene object.

11. The non-transitory computer-readable medium of claim 1, wherein the narrative transition logic is configured to support a guided walkthrough mode and an exploration mode for the first data narrative.

12. A toolkit for generating an immersive data story for presentation on a spatial computing device, comprising:
a data asset management module configured to receive structured data, storytelling assets, and one or more three-dimensional models and to bind the structured data to visual assets associated with the immersive data story;
a spatial scene construction module configured to generate scene objects, spatial metadata, temporal sequencing, and interaction handlers defining a scene graph for the immersive data story;
a storytelling asset generation module configured to generate, based on the structured data and the scene graph, one or more data cards, spatial markers, and audio narratives associated with locations represented in the immersive data story; and
a rendering engine configured to render, based on the scene graph, a macro-level overview and one or more location-specific immersive scenes for interactive presentation on the spatial computing device.

13. The toolkit of claim 12, wherein the spatial scene construction module is configured to generate the scene graph to include the scene objects, the spatial metadata, and the interaction handlers associated with the immersive data story.

14. The toolkit of claim 12, wherein the storytelling asset generation module is configured to generate one or more spatial markers anchored to corresponding spatial locations represented in the immersive data story.

15. The toolkit of claim 14, wherein the spatial scene construction module is configured to generate the scene graph such that gaze-based selection of a selected one of the one or more spatial markers triggers a transition between the macro-level overview and a corresponding one of the one or more location-specific immersive scenes.

16. The toolkit of claim 12, wherein the storytelling asset generation module is configured to generate one or more data cards comprising contextual data associated with respective spatial locations represented in the immersive data story.

17. A method for generating an immersive data story in a spatial computing environment, comprising:
providing, by a data processing module, structured storytelling data and one or more three-dimensional models corresponding to the immersive data story;
processing, by a storytelling engine, the structured storytelling data to generate scene sequencing, narration, and branching logic for the immersive data story;
rendering, by a rendering engine and based on the structured storytelling data and the one or more three-dimensional models, a macro-level overview comprising a data dashboard and a location-specific immersive scene corresponding to a spatial location represented in the immersive data story;
receiving, by a user interactivity controls module, gesture inputs, gaze inputs, and voice commands from a user;
causing, by the user interactivity controls module and based on the gesture inputs, the gaze inputs, or the voice commands, a transition between the macro-level overview and the location-specific immersive scene; and
adapting, by the storytelling engine, the scene sequencing, the narration, or the branching logic based on the gesture inputs, the gaze inputs, or the voice commands received from the user.

18. The method of claim 17, further comprising:
presenting a guided mode in which the scene sequencing and the narration are presented according to a predefined narrative progression; and
enabling a free exploration mode in which a user selectively navigates among spatial locations represented in the immersive data story.

19. The method of claim 17, further comprising rendering one or more spatial markers anchored to corresponding spatial locations in the location-specific immersive scene.

20. The method of claim 19, wherein receiving the gaze inputs comprises detecting a gaze directed to a selected one of the one or more spatial markers, the method further comprising causing, responsive to selection of the selected one of the one or more spatial markers, the transition between the macro-level overview and the location-specific immersive scene corresponding to the selected one of the one or more spatial markers.
